(19) United States
(12) Patent Application Publication
(10) Pub. No.: US 2025/0374098 A1
(43) Pub. Date: Dec. 4, 2025

(54) BEAM PREDICTION MONITORING REFERENCE SIGNALS AND ASSOCIATED PROTOCOLS AND SIGNALING FOR ARTIFICIAL INTELLIGENCE AND MACHINE LEARNING MODEL PERFORMANCE MONITORING

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/873,780

(22) PCT Filed: Aug. 22, 2022
(86) PCT No.: PCT/CN2022/113855

§ 371 Date: Dec. 11, 2024

(51) Int. Cl. H04W 24/10; H04L 5/00

(52) U.S. Cl. CPC H04W 24/10; H04L 5/0051

(57) ABSTRACT

Wireless communication devices, systems, and methods related to beam prediction monitoring reference signals (BPM-RSs) for monitoring the performance of artificial intelligence (AI) and/or machine learning (ML) models including associated protocols and signaling, are provided. For example, a method of wireless communication performed by a user equipment (UE) can include receiving a first beam prediction management reference signal (BPM-RS) configuration, wherein the first BPM-RS configuration indicates one or more BPM-RS resources; monitoring, based on the first BPM-RS configuration, performance of a machine learning (ML) model; and transmitting, to a network unit, a report based on the monitoring.

### TECHNICAL FIELD

This application relates to wireless communication systems, and more particularly to methods—and associated devices and systems—related to beam prediction monitoring reference signals (BPM-RSs) for monitoring the performance of artificial intelligence (AI) and/or machine learning (ML) models, including associated protocols and signaling.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. The radio frequency channel through which the BS and the UE communicate may have several channel properties that are considered for proper channel performance. The BS and UE may perform channel sounding to better understand these channel properties by measuring and/or estimating various parameters of the channel, such as delay, path loss, absorption, multipath, reflection, fading, doppler effect, among others. These channel measurements can also be used for channel estimation and channel equalization.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) includes receiving a first beam prediction management reference signal (BPM-RS) configuration, wherein the first BPM-RS configuration indicates one or more BPM-RS resources; monitoring, based on the first BPM-RS configuration, performance of a machine learning (ML) model; and transmitting, to a network unit, a report based on the monitoring. Associated devices, systems, means, and/or non-transitory computer readable media having one or more instructions for execution by one or more processors of a UE are also provided.

In an additional aspect of the disclosure, a method of wireless communication performed by a network unit includes transmitting, to a user equipment (UE), a first beam prediction management reference signal (BPM-RS) configuration, wherein the first BPM-RS configuration indicates one or more BPM-RS resources; and receiving, from the UE, a report, wherein the report is associated with the UE monitoring a performance of a machine learning (ML) model based on the first BPM-RS configuration. Associated devices, systems, means, and/or non-transitory computer readable media having one or more instructions for execution by one or more processors of a network unit are also provided.

In an additional aspect of the disclosure, a user equipment (UE) includes a memory; a transceiver; and a processor in communication with the memory and the transceiver, wherein the UE is configured to: receive a first beam prediction management reference signal (BPM-RS) configuration, wherein the first BPM-RS configuration indicates one or more BPM-RS resources; monitor, based on the first BPM-RS configuration, performance of a machine learning (ML) model; and transmit, to a network unit, a report based on the monitoring.

In an additional aspect of the disclosure, a network unit includes a memory; a transceiver; and a processor in communication with the memory and the transceiver, wherein the network unit is configured to: transmit, to a user equipment (UE), a first beam prediction management reference signal (BPM-RS) configuration, wherein the first BPM-RS configuration indicates one or more BPM-RS resources; and receive, from the UE, a report, wherein the report is associated with the UE monitoring a performance of a machine learning (ML) model based on the first BPM-RS configuration.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates a time domain beam prediction scheme according to some aspects of the present disclosure.

FIG. 4 illustrates a spatial domain beam prediction scheme according to some aspects of the present disclosure.

FIG. 5 illustrates a spatial domain beam prediction scheme according to one or more aspects of the present disclosure.

FIG. 6 illustrates a signaling diagram for a machine learning (ML) model monitoring scheme according to one or more aspects of the present disclosure.

FIG. 7 illustrates a communication and beam prediction monitoring configurations for a ML model monitoring scheme according to one or more aspects of the present disclosure.

FIG. 8A illustrates communications for a ML model monitoring scheme according to one or more aspects of the present disclosure.

FIG. 8B illustrates communications for a ML model monitoring scheme according to one or more aspects of the present disclosure.

FIG. 8C illustrates communications for a ML model monitoring scheme according to one or more aspects of the present disclosure.

FIG. 9 illustrates communications for a ML model monitoring scheme according to one or more aspects of the present disclosure.

FIG. 10 illustrates a block diagram of a user equipment (UE) according to one or more aspects of the present disclosure.

FIG. 11 illustrates a block diagram of a network unit according to one or more aspects of the present disclosure.

FIG. 12 illustrates a flow diagram of a wireless communication method according to some aspects of the present disclosure.

FIG. 13 illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communication networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof, and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3 GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, and/or as instructions stored on a computer readable medium for execution on a processor or computer. Furthermore, an aspect may comprise at least one element of a claim.

Aspects of the present disclosure allow a UE and/or network unit to monitor the performance of one or more machine-learning (ML) models, including ML models for beam prediction. A wireless channel between the network (e.g., a BS) and a UE may vary over time. The BS may configure a set of beams for the UE, which at any point of time may use one or two serving beams to receive DL transmissions from or transmit UL transmissions to the BS. The BS and the UE may keep track of the serving beam(s) as well as candidate beams. For example, the UE may perform one or more measurements of one or more reference signals configured for the UE and may include the one or more measurements in a channel state information (CSI) report. If a serving beam fails, the BS may reconfigure the UE to use of the candidate beams. Candidate beams may be regularly updated because the channel quality between the BS and the UE may change over time. It may be desirable for the UE update the serving beam(s) according to the channel state. The UE may report the link quality of the serving beam(s) and the candidate beams in a CSI report to the BS, and the BS may process the CSI report and determine whether the UE's serving beam(s) or candidate beam(s) should be reconfigured. If the quality of a beam falls below a threshold, the BS may reconfigure a beam the UE's serving beam(s) or candidate beam(s). The BS may configure the threshold. Based on the determination, the BS may transmit a command to reconfigure the UE's serving beam(s) and/or candidate beam(s) in response to the CSI report.

The BS may configure the UE to periodically report the CSI report to the BS. The CSI report may include, for example, channel quality information (CQI) and/or reference signal received power (RSRP). CQI is an indicator carrying information on the quality of a communication channel. The BS may use the CQI to assist in downlink (DL) scheduling. The BS may use the RSRP to manage beams in multi-beam operations. The UE may perform different combinations of measurements for inclusion in the CSI report. Accordingly, the UE may transmit a CSI report including the CQI but not the RSRP, a CSI report including the RSRP but not the CQI, and/or a CSI report including both the CQI and the RSRP.

In 5G NR, machine learning (ML) algorithms are being implemented to assist cellular network performance. These ML algorithms may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

At each node implemented with one or more ML algorithms, the ML algorithms may interact with different layers within the node. The ML algorithms may interact with one of the physical layer (PHY), the media access control (MAC) layer or upper layers (e.g., application layer) in some instances, or with multiple layers in other instances. These ML algorithms may involve various ML-related data transfers between different layers of different nodes (e.g., UE, BS, central cloud server). The ML algorithms may be trained with training datasets that are produced through periodic and/or aperiodic data collection at one or more nodes. In various aspects, measurement data collection serves as input to the ML modules. The operation of these ML algorithms at the different nodes may be used for ML model parameter transfer and/or update. The ML model framework within the wireless communication network has the capability to send feedback signals and/or reports between the different nodes. In various aspects, the UE may feedback channel measurements that are indicative of the ML model prediction accuracy. For example, the measurement data collection by the UE may be sent to the BS and/or central cloud server with a report may indicate that the ML model is producing prediction errors, thus indicative that the ML model has failed and/or requires updating.

In various aspects, the UE may include different ML algorithms on board to predict channel properties for a future use of that channel. For example, the machine learning-based network may be implemented by a channel property prediction network to predict one or more properties of a channel and/or one or more beam parameters. In some aspects, the ML algorithms are tasked to predict what transmission beam(s) to use for the BS and/or reception beam(s) to use for the UE. For example, the machine learning-based network may be implemented by a beam selection prediction network to predict the BS transmission beam(s) and/or the UE reception beam(s).

The present disclosure provides techniques for a UE and/or network unit to monitor the performance of one or more machine-learning (ML) models, including ML models for beam prediction. In this regard, the UE and/or network unit can stop the ML model, initiate a retraining of the ML model, and/or adjust one or more operating parameters of the ML model upon detecting a failure of the ML model. Aspects of the present disclosure provide beam prediction monitoring reference signals (BPM-RSs) and associated protocols and signaling to allow the UE and the network unit to be coordinated as the monitoring and/or operation (or non-operation) of a ML model. As described herein, in addition to the coordination benefits, aspects of the present disclosure provide improved network efficiency, improved allocation of network resources, reduced power consumption by the UEs and/or the network units, and/or improved utilization of ML models.

In some aspects, a UE may be RRC-configured with one or multiple BPM-RS resources. In some instances, the BPM-RS resources may be linked or associated with one or multiple periodic, semi-persistent, and/or aperiodic NZP-CSI-RS resource set(s). Each BPM-RS resource may be transmitted by a network unit based on a same spatial transmit filter as at least one beam that the UE will use a machine learning (ML) model to predict (and optionally report) an associated L1-RSRP, L1-SINR, RI, PMI, CQI, LI, and/or other measurement/parameter. In some aspects, the beam and the BPM-RS resource may be associated with each other through separate signaling from the network unit. Such BPM-RS resources may be configured per serving cell and/or per bandwidth part.

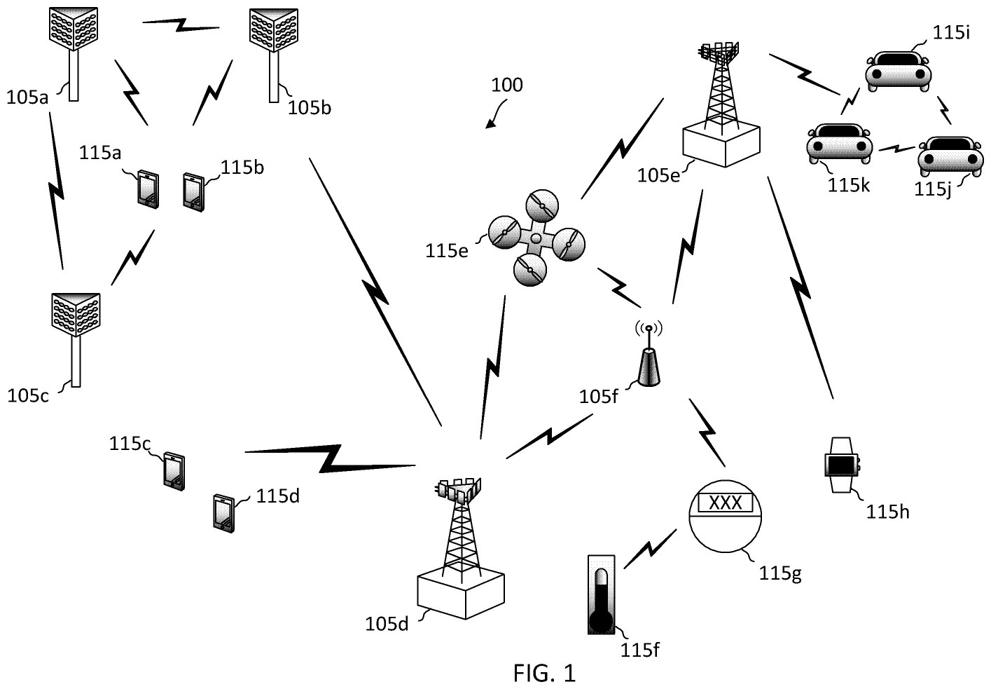

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL and/or UL, desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal can have a particular pilot pattern or structure, where pilot tones may span across an operational BW or frequency band, each positioned at a pre-defined time and a pre-defined frequency. For instance, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response can be referred to as message 1 (MSG1), message 2 (MSG2), message 3 (MSG3), and message 4 (MSG4), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For instance, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For instance, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

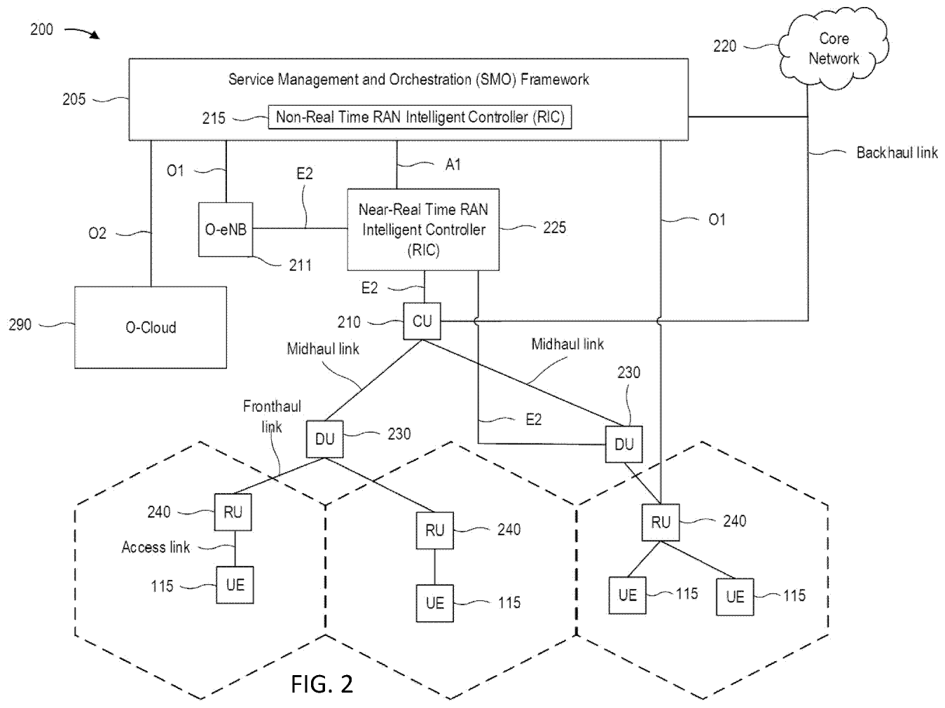

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

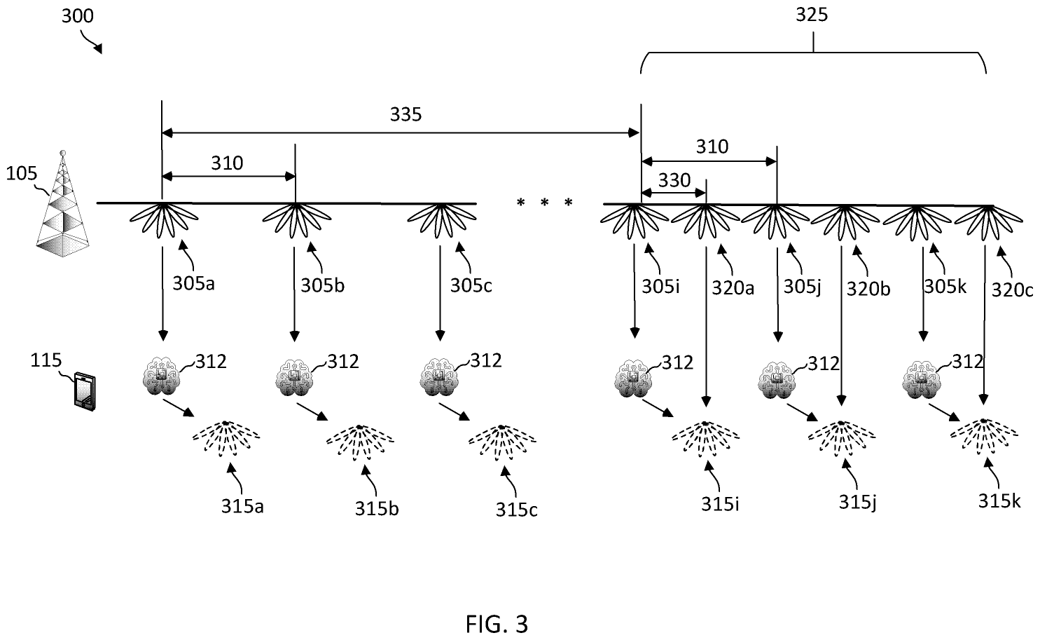

FIG. 3 illustrates a time domain beam prediction scheme 300 according to some aspects of the present disclosure. The time domain beam prediction scheme 300 illustrates aspects of predicting one or more beam characteristics using a machine learning (ML) model in accordance with the present disclosure. In this regard, aspects of the time domain beam prediction scheme 300 may be utilized in the context of the wireless communication network 100 as well as with other aspects of the present disclosure, including the spatial domain beam prediction schemes 400 and 500 and the ML model monitoring schemes 600 and 700.

As shown, a BS 105 may periodically transmit one or more reference signals (e.g., downlink reference signals, CSI-RS, CRS, SSB, etc.). In the illustrated example, the BS 105 transmits a nominal reference signal group 305a, 305b, 305c with a period 310 (e.g., 10 ms, 20 ms, 40 ms, or any other suitable period). In some aspects, the period 310 may be longer (e.g., twice the period, or otherwise) than a standard reference signal period, which can allow for power savings, reduced network congestion, and/or reduced interference by omitting one or more transmissions of reference signals relative to the standard reference signal period.

A UE 115 may utilize one or more ML models 312 to predict one or more beam parameters based on the reference signals received from the BS 105. Unless otherwise noted, it is understood that reference to a ML model in the present disclosure includes any type of program that relies on machine learning, including without limitation ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

The UE 115 may utilize a ML model 312 to predict one or more beam parameters for a predicted beam group (e.g., predicted beam group 315a, 315b, or 315c) based on a nominal reference signal group (e.g., nominal reference signal group 305a, 305b, or 305c). In this regard, the ML model 312 executed by the UE 115 may utilize measurements and/or other information associated with the nominal reference signal group (e.g., 305a, 305b, or 305c) along with other pertinent parameters (e.g., UE mobility, UE location, etc.) and/or previously acquired data to determine one or more beam parameters (e.g., predicted beam measurements, predicted beam ranking order, etc.) for the predicted beam group (e.g., 315a, 315b, or 315c).

The predicted beam group may be associated with a future reference signal monitoring occasion (e.g., the reference signal monitoring occasions associated with nominal reference signal groups 305b or 305c) and/or between reference signal monitoring occasions. For example, FIG. 3 illustrates an instance where the predicted beam groups (e.g., predicted beam groups 315a and 315b) are associated with a time period between reference signal monitoring occasions (e.g., between the reference signal monitoring occasions associated with nominal reference signal groups 305a and 305b for predicted beam group 315a and between the reference signal monitoring occasions associated with nominal reference signal groups 305b and 305c for predicted beam group 315b). In some instances, the predicted beam groups are associated with time periods between reference signal monitoring occasions where reference signal transmissions are omitted but would occur if a standard reference signal periodicity was being used.

The BS 105 may periodically transmit one or more beam prediction monitoring reference signal (BPM-RS) groups 320a, 320b, 320c during a ML model evaluation period 325. In some instances, the BPM-RS groups 320a, 320b, 320c are spaced from a nominal reference signal group 305i, 305j, 305k by a period 330 (e.g., 5 ms, 10 ms, 20 ms, or any other suitable period). In some aspects, the period 330 may be a standard reference signal period. For example, in some instances, the BPM-RS groups 320a, 320b, 320c may be transmitted in standard reference signal transmission occasions that are omitted outside of the ML model evaluation period 325. Further, in some instances the ML model evaluation period 325 may occur periodically (e.g., based on period 335 (e.g., 100 ms, 500 ms, or other suitable period)) and/or ad hoc. In some instances, the BS 105 may indicate the timing of the ML model evaluation period 325 in a BPM-RS configuration, a ML model monitoring configuration, radio resource control (RRC) message, and/or other suitable communication.

The BPM-RS groups 320a, 320b, 320c may be utilized by the UE 115 to evaluate the performance of the ML model 312. For example, the UE 115 may utilize the ML model 312 to predict one or more beam parameters for a predicted beam group (e.g., predicted beam group 315i, 315j, or 315k) based on a nominal reference signal group (e.g., nominal reference signal group 305i, 305j, or 305k). Each predicted beam group (e.g., predicted beam group 315i, 315j, or 315k) may be associated with a BPM-RS group (e.g., BPM-RS group 320a, 320b, or 320c). In this regard, one or more measurements for the BPM-RS group that the predicted beam group is associated with may be utilized to evaluate the performance of the ML model. For example, as discussed further below, measurement(s) for the BPM-RS group may be compared to measurement(s) of predicted beams of the ML model 312 and/or compared to predicted measurement(s) of the predicted beams of the ML model 312 to evaluate the performance of the ML model 312. In this regard, the comparison may indicate that a ML model failure instance (MFI) has occurred. If a sufficient number of MFIs occurs within a period of time (e.g., based on a BPM timer), then it may be an indication that the ML model 312 has failed.

As discussed further below, in response to detecting a failure of the ML model 312, the UE may stop the ML model 312, initiate retraining of the ML model 312, and/or transmit an indication of the failure of the ML model 312 to the BS 105. In some instances, the UE may determine the ML model 312 is operating properly and may continue running the ML model 312 and/or transmit an indication of proper operation of the ML model 312 to the BS 105.

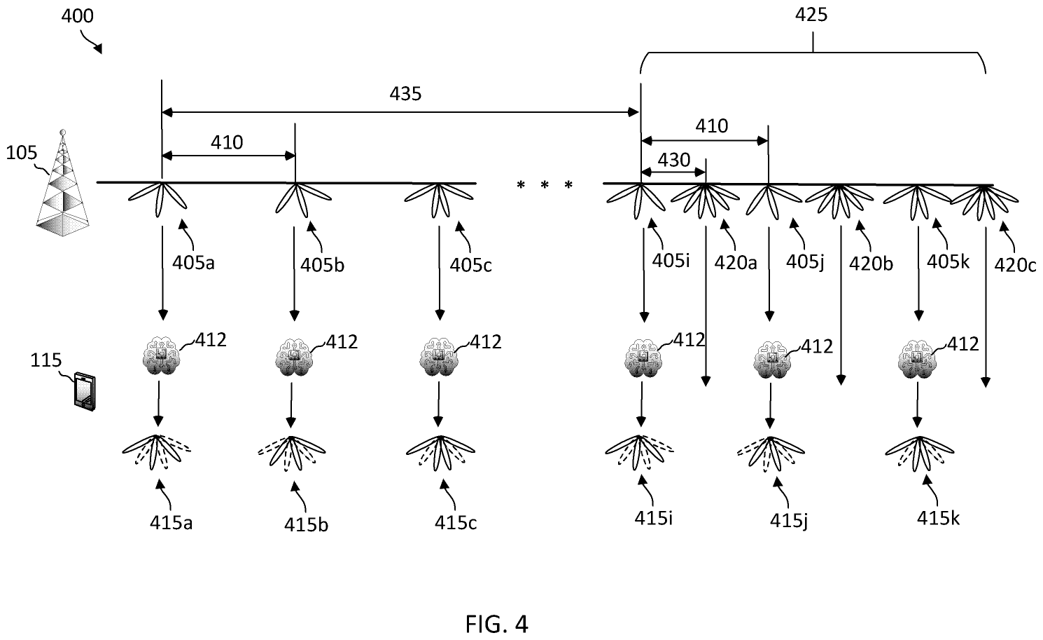

FIG. 4 illustrates a spatial domain beam prediction scheme 400 according to some aspects of the present disclosure. The spatial domain beam prediction scheme 400 illustrates aspects of predicting one or more beam characteristics using a machine learning (ML) model in accordance with the present disclosure. In this regard, aspects of the spatial domain beam prediction scheme 400 may be utilized in the context of the wireless communication network 100 as well as with other aspects of the present disclosure, including the time domain beam prediction scheme 300, the spatial domain beam prediction scheme 500, and the ML model monitoring schemes 600 and 700.

As shown, a BS 105 may periodically transmit one or more reference signals (e.g., downlink reference signals, CSI-RS, CRS, SSB, etc.). In the illustrated example, the BS 105 transmits a nominal reference signal group 405a, 405b, 405c with a period 410 (e.g., 10 ms, 20 ms, 40 ms, or any other suitable period). In some aspects, the period 410 may be longer (e.g., twice the period, or otherwise) than a standard reference signal period, which can allow for power savings, reduced network congestion, and/or reduced interference by omitting one or more transmissions of reference signals relative to the standard reference signal period. As shown, for each nominal reference signal group 405a, 405b, and 405c the BS may transmit the reference signals using less than all of the available and/or active beam directions. In this regard, the beam direction(s) transmitted for each of nominal reference signal group 405a, 405b, and 405c may include the same and/or different beam directions than the other nominal reference signal groups 405a, 405b, and 405c.

A UE 115 may utilize one or more ML models 412 to predict one or more beam parameters based on the nominal reference signals received from the BS 105. The UE 115 may utilize a ML model 412 to predict one or more beam parameters for a predicted beam group (e.g., predicted beam group 415a, 415b, or 415c) based on a nominal reference signal group (e.g., nominal reference signal group 405a, 305b, or 305c). In this regard, the ML model 412 executed by the UE 115 may utilize measurements and/or other information associated with the nominal reference signal group (e.g., 405a, 405b, or 405c) along with other pertinent parameters (e.g., UE mobility, UE location, etc.) and/or previously acquired data to determine one or more beam parameters (e.g., predicted beam measurements, predicted beam ranking order, etc.) for the predicted beam group (e.g., 415a, 415b, or 415c). More specifically, the UE 115 may utilize the ML model 412 to estimate one or more beam parameters for the beam directions that were not transmitted as part of the reference signals of the corresponding nominal reference signal groups 405a, 405b, and 405c. In this regard, the solid lines in the predicted beam groups 415a, 415b, and 415c, the UE 115 represent the beam directions that were transmitted as part of the reference signals of the corresponding nominal reference signal groups 405a, 405b, and 405c, while the dashed lines represent the beam directions that were not transmitted by the corresponding nominal reference signal groups 405a, 405b, and 405c.

The BS 105 may periodically transmit one or more BPM-RS groups 420a, 420b, 420c during a ML model evaluation period 425. In some instances, the BPM-RS groups 420a, 420b, 420c are spaced from a nominal reference signal group 405i, 405j, 405k by a period 430 (e.g., 5 ms, 10 ms, 20 ms, or any other suitable period). In some aspects, the period 430 may be a standard reference signal period. For example, in some instances, the BPM-RS groups 420a, 420b, 420c may be transmitted in standard reference signal transmission occasions that are omitted outside of the ML model evaluation period 425. Further, in some instances the ML model evaluation period 425 may occur periodically (e.g., based on period 435 (e.g., 100 ms, 500 ms, or other suitable period)) and/or ad hoc. In some instances, the BS 105 may indicate the timing of the ML model evaluation period 425 in a BPM-RS configuration, ML model monitoring configuration, radio resource control (RRC) message, and/or other suitable communication.

The BPM-RS groups 420a, 420b, 420c may be utilized by the UE 115 to evaluate the performance of the ML model 412. In this regard, as shown the BPM-RS groups 420a, 420b, 420c may transmit reference signals in all of the available and/or active beam directions, or at least more beam directions than the nominal reference signal groups 405i, 405j, 405k. One or more measurements of the BPM-RS group may be utilized to evaluate the performance of the ML model 412 based on the predicted beam groups 415i, 415j, and 415k. For example, the UE 115 may utilize the ML model 412 to predict one or more beam parameters for beam directions not transmitted as part of a nominal reference signal group (e.g., nominal reference signal group 405i, 405j, or 405k) in generating the predicted beam groups 415i, 415j, and 415k. As discussed further below, measurement(s) for the BPM-RS group may be compared to measurement(s) of predicted beams of the ML model 412 and/or compared to predicted measurement(s) of the predicted beams of the ML model 412 to evaluate the performance of the ML model 412. In this regard, the comparison may indicate that a ML model failure instance (MFI) has occurred. If a sufficient number of MFIs occurs within a period of time (e.g., based on a BPM timer), then it may be an indication that the ML model 412 has failed.

As discussed further below, in response to detecting a failure of the ML model 412, the UE may stop the ML model 412, initiate retraining of the ML model 412, and/or transmit an indication of the failure of the ML model 412 to the BS 105. In some instances, the UE may determine the ML model 412 is operating properly and may continue running the ML model 412 and/or transmit an indication of proper operation of the ML model 412 to the BS 105.

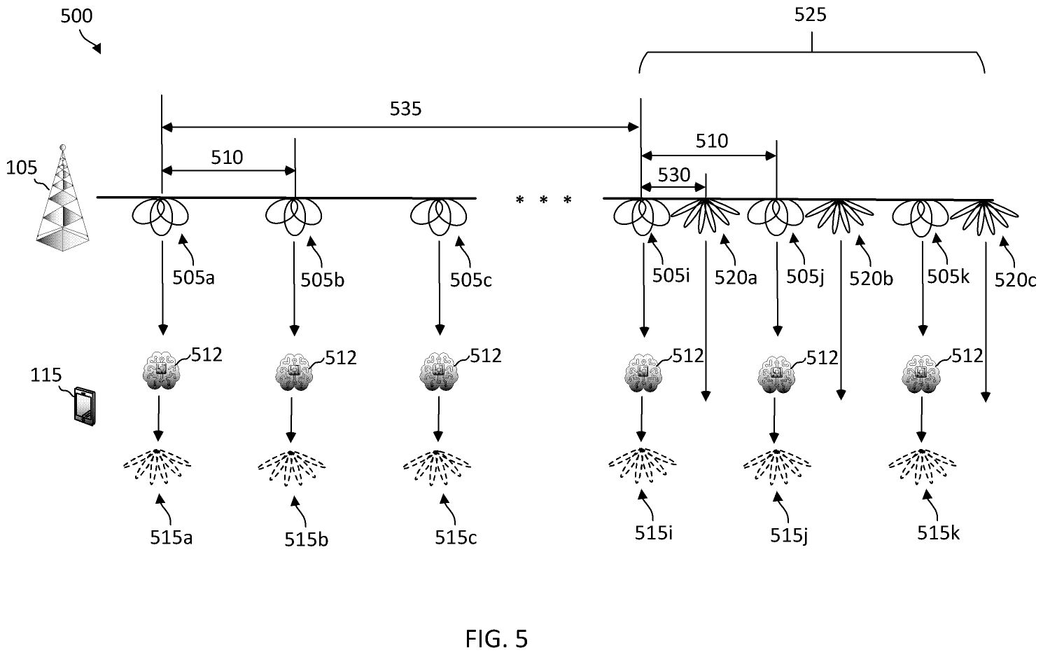

FIG. 5 illustrates a spatial domain beam prediction scheme 500 according to one or more aspects of the present disclosure. The spatial domain beam prediction scheme 500 illustrates aspects of predicting one or more beam characteristics using a machine learning (ML) model in accordance with the present disclosure. In this regard, aspects of the spatial domain beam prediction scheme 500 may be utilized in the context of the wireless communication network 100 as well as with other aspects of the present disclosure, including the time domain beam prediction scheme 300, the spatial domain beam prediction scheme 400, and the ML model monitoring schemes 600 and 700.

As shown, a BS 105 may periodically transmit one or more reference signals (e.g., downlink reference signals, CSI-RS, CRS, SSB, etc.). In the illustrated example, the BS 105 transmits a nominal reference signal group 505a, 505b, 505c with a period 510 (e.g., 10 ms, 20 ms, 40 ms, or any other suitable period). In some aspects, the period 510 may be longer (e.g., twice the period, or otherwise) than a standard reference signal period, which can allow for power savings, reduced network congestion, and/or reduced interference by omitting one or more transmissions of reference signals relative to the standard reference signal period. As shown, for each nominal reference signal group 505a, 505b, and 505c the BS using wideband beams. In this regard, the wideband beams transmitted for each of nominal reference signal group 505a, 505b, and 505c may include the same and/or different wideband beams as the other nominal reference signal groups 505a, 505b, and 505c.

A UE 115 may utilize one or more ML models 512 to predict one or more beam parameters based on the nominal reference signals received from the BS 105. The UE 115 may utilize a ML model 512 to predict one or more beam parameters for a predicted beam group (e.g., predicted beam group 515a, 515b, or 515c) based on a nominal reference signal group (e.g., nominal reference signal group 505a, 505b, or 505c). In this regard, the ML model 512 executed by the UE 115 may utilize measurements and/or other information associated with the nominal reference signal group (e.g., 505a, 505b, or 505c) along with other pertinent parameters (e.g., UE mobility, UE location, etc.) and/or previously acquired data to determine one or more beam parameters (e.g., predicted beam measurements, predicted beam ranking order, etc.) for the predicted beam group (e.g., 515a, 515b, or 515c). More specifically, the UE 115 may utilize the ML model 512 to estimate one or more beam parameters for the narrowband beams that were not transmitted as part of the wideband reference signals of the corresponding nominal reference signal groups 505a, 505b, and 505c. In this regard, while FIG. 5 shows transmission of wideband reference signals and prediction of narrowband beams, in other aspects of the present disclosure narrowband reference signals may be transmitted and a ML model may be utilized to predict one or more beam parameters for wideband beams based on the narrowband reference signals.

The BS 105 may periodically transmit one or more BPM-RS groups 520a, 520b, 520c during a ML model evaluation period 525. In some instances, the BPM-RS groups 520a, 520b, 520c are spaced from a nominal reference signal group 505i, 505j, 505k by a period 530 (e.g., 5 ms, 10 ms, 20 ms, or any other suitable period). In some aspects, the period 530 may be a standard reference signal period. For example, in some instances, the BPM-RS groups 520a, 520b, 520c may be transmitted in standard reference signal transmission occasions that are omitted outside of the ML model evaluation period 525. Further, in some instances the ML model evaluation period 525 may occur periodically (e.g., based on period 535 (e.g., 100 ms, 500 ms, or other suitable period)) and/or ad hoc. In some instances, the BS 105 may indicate the timing of the ML model evaluation period 525 in a BPM-RS configuration, a ML model monitoring configuration, radio resource control (RRC) message, and/or other suitable communication.

The BPM-RS groups 520a, 520b, 520c may be utilized by the UE 115 to evaluate the performance of the ML model 512. In this regard, as shown the BPM-RS groups 520a, 520b, 520c may transmit narrowband reference signals in one or more of the available and/or active beam directions and/or in one or more of the beam directions predicted by ML model 512 for the predicted beam groups 515i, 515j, 515k based on the nominal reference signal groups 505i, 505j, 505k. In this regard, one or more measurements of the BPM-RS group may be utilized to evaluate the performance of the ML model 512 based on the predicted beam groups 515i, 515j, and 515k. For example, the UE 115 may utilize the ML model 512 to predict one or more beam parameters for the narrowband beam directions not transmitted as part of a nominal reference signal group (e.g., nominal reference signal group 505i, 505j, or 505k) in generating the predicted beam groups 515i, 515j, and 515k. As discussed further below, measurement(s) for the BPM-RS group may be compared to measurement(s) of predicted beams of the ML model 512 and/or compared to predicted measurement(s) of the predicted beams of the ML model 512 to evaluate the performance of the ML model 512. In this regard, the comparison may indicate that a ML model failure instance (MFI) has occurred. If a sufficient number of MFIs occurs within a period of time (e.g., based on a BPM timer), then it may be an indication that the ML model 412 has failed.

As discussed further below, in response to detecting a failure of the ML model 512, the UE may stop the ML model 512, initiate retraining of the ML model 512, and/or transmit an indication of the failure of the ML model 512 to the BS 105. In some instances, the UE may determine the ML model 512 is operating properly and may continue running the ML model 512 and/or transmit an indication of proper operation of the ML model 512 to the BS 105.

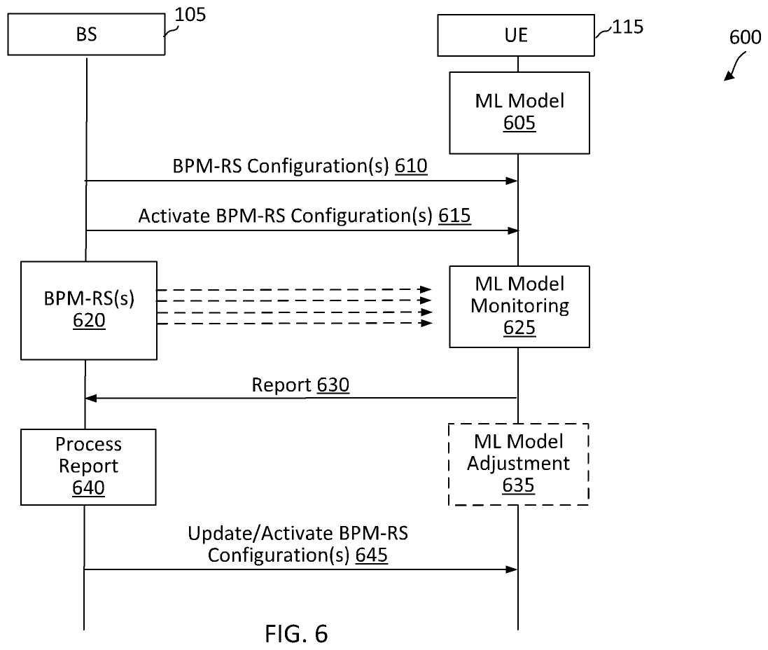

FIG. 6 illustrates a signaling diagram for a machine learning (ML) model monitoring scheme 600 according to one or more aspects of the present disclosure. The ML model monitoring scheme 600 illustrates aspects of monitoring the performance of a ML model in accordance with the present disclosure. In this regard, aspects of the ML model monitoring scheme 600 may be utilized in the context of the wireless communication network 100 as well as with other aspects of the present disclosure, including the time domain beam prediction scheme 300, the spatial domain beam prediction schemes 400 and 500, and the ML model monitoring schemes 700, 800, 810, 820, and 900.

At action 605, a UE 115 runs a ML model. The ML model run by the UE 115 may include any type of program that relies on machine learning, including without limitation ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

In some aspects of the present disclosure, the ML model is configured to predict one or more beam parameters, including without limitation predicted beam measurements (e.g., a level 1 reference signal receive power (L1-RSRP), a level 1 signal to interference noise ratio (L1-SINR), a rank indicator (RI), a precoding matrix indicator (PMI), a channel quality indicator (CQI), layer indicator (LI), and/or other predicted measurement/indicator), narrowband beams, wideband beams, etc. In some instances, the ML model(s) may include an ML model utilized by the UE 115 for beam prediction. For example, the ML model may be configured to provide a time domain beam prediction (e.g., as discussed with respect to FIG. 3) and/or a spatial domain beam prediction (e.g., as discussed with respect to FIGS. 4 and 5). In some instances, the UE 115 may run multiple ML models. The multiple ML models may perform similar and/or different functions.

At action 610, a BS 105 transmits a beam prediction monitoring reference signal (BPM-RS) configuration to the UE 115. In some instances, the action 610 occurs before the action 605. That is, in some instances the UE 115 may receive the BPM-RS configuration before starting the ML model. In other instances, the UE 115 may start the ML model before receiving the BPM-RS configuration. In some aspects, the UE 115 may receive an initial BPM-RS configuration and subsequently receive an updated BPM-RS configuration. In this regard the BS 105 may update one or more parameters of the BPM-RS configuration and transmit an updated BPM-RS configuration and/or an indication of the updated parameter(s). Further, in some instances the BS may transmit a plurality of BPM-RS configurations to the UE 115 at action 610.

The UE 115 may receive the BPM-RS configuration(s) and/or any updates to the BPM-RS configuration(s) from the BS 105 via a radio resource control (RRC) message or other suitable communication. In some aspects, the BPM-RS configuration(s) may be included as an information element of the communication. The BPM-RS configuration(s) may include one or more parameters associated with ML model monitoring and/or reporting. For example, the BPM-RS configuration may indicate one or more BPM-RS resources. Generally, the BPM-RS resource(s) may include time resources, frequency resources, and/or beam directions (e.g., antenna port(s)) associated with one or more BPM-RSs. In this regard, the BPM-RS resources may be associated with periodic BPM-RSs, semi-persistent BPM-RSs, and/or aperiodic BPM-RSs. In some instances, the BPM-RS resources may be associated with one or more beams (e.g., one or more beams of BPM-RS groups 320a, 320b, 320c, 420a, 420b, 420c, 520a, 520b, 520c) that the UE 115 utilizes to evaluate performance of one or more ML models. In some instances, the one or more BPM-RS resources may be associated with one or more non-zero power channel state information reference signal (NZP-CSI-RS) resources and/or other reference signal resources. In some instances, the BPM-RS configuration(s) may be associated with a serving cell and/or a bandwidth part. In this regard, each serving cell and/or bandwidth part may be associated with one or more BPM-RS configurations. The UE 115 may utilize information from the BPM-RS configuration to evaluate the performance of one or more ML models.

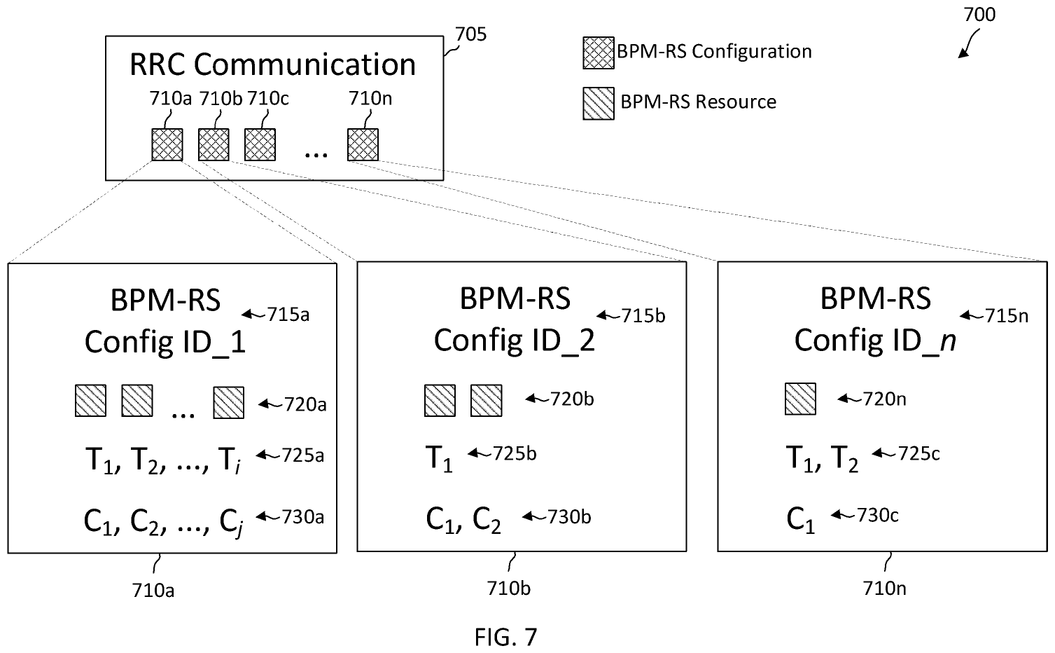

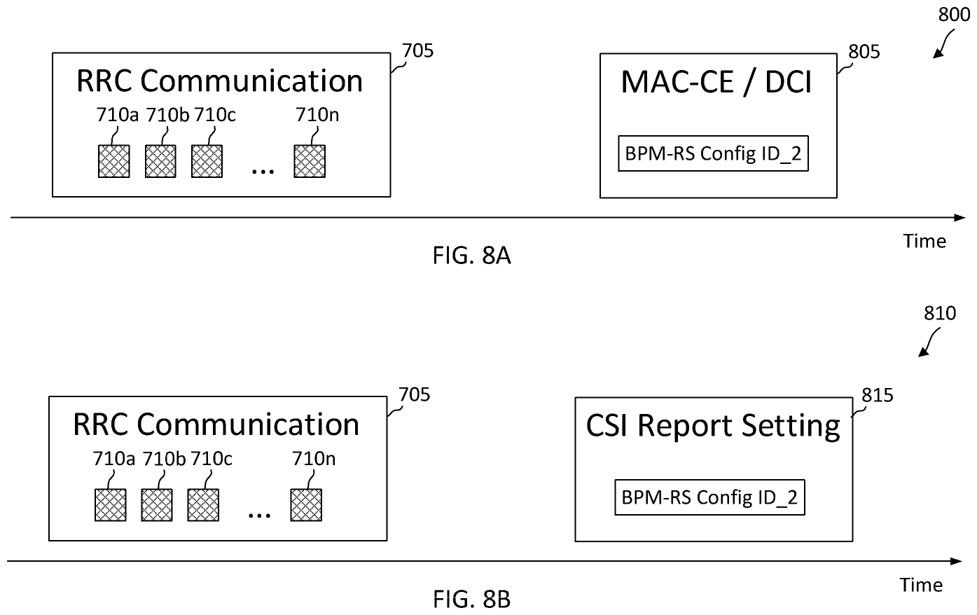

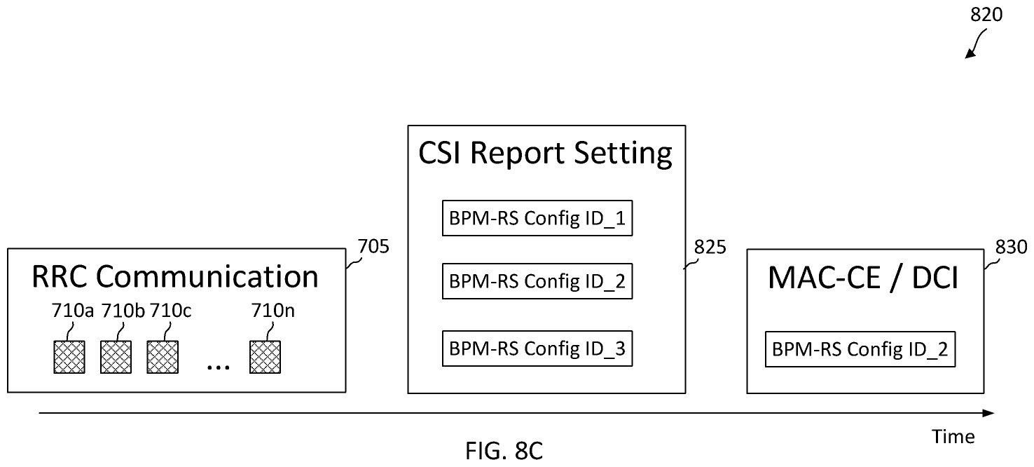

In some instances, at action 610, the UE 115 receives a plurality of BPM-RS configurations (e.g., as shown in FIGS. 7-8C). Each of the plurality of BPM-RS configurations may be associated with at least one of a serving cell or a bandwidth part. In some aspects, the UE 115 receives the plurality of BPM-RS configurations via an RRC communication.

At action 615, the UE 115 may receive an indication to activate and/or use one or more BPM-RS configurations (e.g., a first BPM-RS configuration) of the BPM-RS configurations received at action 610. The UE 115 may receive the indication to activate and/or use the one or more BPM-RS configurations (e.g., the first BPM-RS configuration) of the plurality of BPM-RS configurations, at action 615, via a media access control control element (MAC-CE) and/or downlink control information (DCI) (e.g., as shown in FIGS. 8A-8C). In this regard, in some instances the MAC-CE and/or the DCI may include an identifier (or an indication of the identifier) associated with each of the BPM-RS configuration(s) the UE 115 is to utilize. In other instances, action 615 is omitted and the UE 115 receiving the BPM-RS configuration(s) at action 610 serves as indication for the UE 115 to activate and/or use the received BPM-RS configuration(s).

In some instances, the UE 115 receives an indication to use one or more BPM-RS configurations of a plurality of BPM-RS configurations, at action 615, by receiving a channel state information (CSI) report setting including multiple BPM-RS configuration identifiers (or indications of the BPM-RS configuration identifiers) associated with one or more of the plurality of BPM-RS configuration(s) (e.g., as shown in FIG. 8C). The multiple BPM-RS configuration indicated in the CSI report setting may be one or more, including all, of the BPM-RS configurations of the plurality of BPM-RS configurations received at action 610. The UE 115 may then receive an indication indicating one or more BPM-RS configurations of the multiple BPM-RS configurations indicated in the CSI report setting that the UE 115 is to utilize. The UE 115 may receive the indication to use the one or more BPM-RS configurations (e.g., the first BPM-RS configuration) of the multiple of BPM-RS configurations via a MAC-CE and/or DCI (e.g., as shown in FIG. 8C). In this regard, in some instances the MAC-CE and/or the DCI may include an identifier (or an indication of the identifier) associated with each of the BPM-RS configuration(s) the UE 115 is to utilize. In some instances, the UE 115 receives the indication to use the one or more BPM-RS configurations of the plurality of BPM-RS configurations by receiving a CSI report setting including one or more BPM-RS configuration identifiers (or indications of the BPM-RS configuration identifiers) associated with the one or more BPM-RS configurations the UE 115 is to utilize.

In some aspects, for periodic CSI reports, the associated CSI report setting may include the BPM-RS Configuration ID. For semi-persistent and/or aperiodic CSI reports, the associated CSI report setting may include multiple BPM-RS configuration identifiers and a MAC-CE activating the CSI report may indicate one BPM-RS configuration identifier. The UE may utilize the BPM-RS configuration indicated in the MAC-CE for ML model performance monitoring. In some aspects, the aperiodic CSI triggering state configurations associated with a CSI report setting may include respective BPM-RS configuration identifiers and a DCI triggering the aperiodic CSI report may indicate the specific BPM-RS configuration the UE is to utilize.

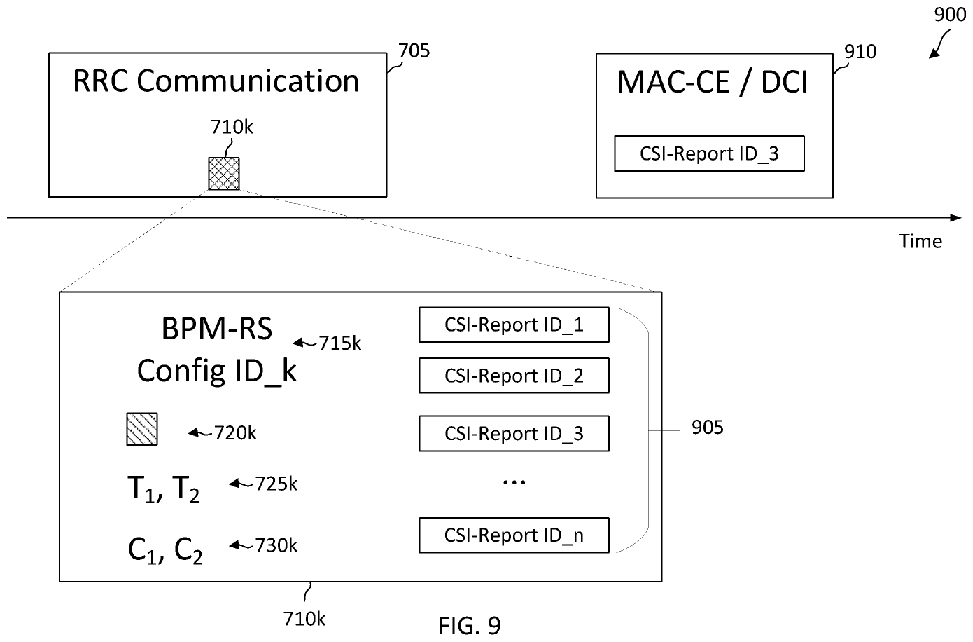

In some aspects, one or more of the BPM-RS configurations received at block 1210 includes a plurality of channel state information (CSI) report setting identifiers (or indications of the identifiers) (e.g., as shown in BPM-RS configuration 710k of FIG. 9). When the BPM-RS configuration includes a plurality of CSI report setting identifiers or associated indicators, the UE 115 may receive, from the BS 105, an indication to use a particular CSI report setting (e.g., a first CSI report setting) of the plurality of CSI report settings. For example, in some instances, the UE 115 may receive a MAC-CE and/or DCI including an indication to use the particular CSI report setting. In this regard, the MAC-CE and/or the DCI may include the identifier (or an indication of the identifier) for the CSI report setting that the UE 115 is to utilize. In some instances, the DCI may have a particular format and/or use a particular radio network temporary identifier (RNTI) when indicating a CSI report setting to use when multiple CSI report settings are associated with a BPM-RS configuration. As discussed further below, the UE 115 may utilize the associated format and/or parameters for the indicated CSI report setting to send a report to the BS 105 at action 630.

In some instances, the first BPM-RS configuration received at action 610 includes at least one of an indication of a length of a BPM timer (e.g., beamPredictionMonitoringTimer) and/or an indication of a BPM threshold (e.g., beamPredictionErrorCount). In this regard, the UE 115 may utilize the BPM timer and/or the BPM threshold to monitor performance of a ML model as discussed in greater detail below with respect to action 625. In some instances, a common BPM timer length and/or a common BPM threshold may be utilized for two or more BPM-RS configurations. For example, in some instances the UE 115 may receive, at action 610, a plurality of BPM-RS configurations and also receive an indication of a length of a BPM timer and/or receive an indication of a BPM threshold. The length of the BPM timer received by the UE 115 may be associated with each of the plurality of BPM-RS configurations. Similarly, the BPM threshold received by the UE 115 may be associated with each of the plurality of BPM-RS configurations.

In some aspects, the BPM-RS configuration(s) may include an indication of a plurality of lengths of the BPM timer (see, e.g., BPM-RS configurations 710a, 710c, 710k of FIGS. 7 and 9). In this regard, the UE 115 may receive from the BS 105 an indication to use a particular length of the BPM timer (e.g., a first BPM timer length) from among the plurality of lengths. Further, in some instances the UE 115 may receive from the BS 105 a further indication to use a different length of the BPM timer (e.g., a second BPM timer length). In some aspects, the BS 105 may determine the length of the BPM timer for the UE 115 to use and communicate an indication of the selected length to the UE 115. In some instances, the BS 105 may determine to change the length of the BPM timer based on mobility of the UE 115 (e.g., increased movement of the UE 115 may result in a reduced length of the timer), one or more reports from the UE 115, network conditions, and/or other factors. In some instances, the BS 105 may indicate the length of the BPM timer in a CSI report setting and/or a MAC-CE (e.g., activating a periodic CSI-Report) and/or a DCI (e.g., triggering a semi-persistent CSI report and/or an aperiodic CSI report).

In some aspects, the BPM-RS configuration(s) may include an indication of a plurality of BPM thresholds (see, e.g., BPM-RS configurations 710a, 710b, 710k of FIGS. 7 and 9). In this regard, the UE 115 may receive from the BS 105 an indication to use a particular BPM threshold (e.g., a first BPM threshold) from among the plurality of BPM thresholds. Further, in some instances the UE 115 may receive from the BS 105 a further indication to use a different BPM threshold (e.g., a second BPM threshold). In some aspects, the BS 105 may determine the BPM threshold for the UE 115 to use and communicate an indication of the selected BPM threshold to the UE 115. In some instances, the BS 105 may determine to change the BPM threshold based on mobility of the UE 115, one or more reports from the UE 115, network conditions, and/or other factors. In some instances, the BS 105 may indicate the BPM threshold in a CSI report setting and/or a MAC-CE (e.g., activating a periodic CSI-Report) and/or a DCI (e.g., triggering a semi-persistent CSI report and/or an aperiodic CSI report).

In some aspects, the BPM-RS configuration(s) communicated at action 610 may further include one or more other parameters associated with ML model monitoring and/or reporting. For example, the BPM-RS configuration may include one or more values associated with one or more ML model failure criterion (e.g., whether a top-1 predicted beam of the ML model is included in a set of top-K beams of a group of measured beams, whether a top-1 measured beam of a group of measured beams is included in a set of top-K beams of a group of predicted beams of the ML model, whether a layer 1 reference signal receive power (L1-RSRP) or other measurement(s) of a top-1 predicted beam of the ML model is within a threshold difference of an L1-RSRP or other measurement(s) of a top-1 measured beam of a group of measured beams, whether a predicted layer 1 reference signal receive power (L1-RSRP) or other measurement(s) of a top-1 predicted beam of the ML model is within a threshold difference of a measured L1-RSRP or other measurement(s) of a top-1 measured beam of a group of measured beams, etc.) and/or other parameters associated with ML model BPM monitoring and/or reporting.

At action 620, the BS 105 may transmit BPM-RSs in accordance with one or more BPM-RS configurations. In some aspects, the BS 105 transmits at least one BPM-RS for one or more monitoring occasions associated with one or more BPM-RS configurations. For example, the BS 105 may transmit BPM-RSs (e.g., downlink reference signals, CSI-RS, CRS, SSB, etc.) associated with the one or more monitoring occasions as described above with respect to FIGS. 3-5. In this regard, the BS 105 may transmit nominal reference signals (e.g., 305, 405, 505) and/or BPM-RSs (e.g., 320, 420, 520) during normal operation and/or during a ML model evaluation period (e.g., 335, 435, 535).

At action 625, the UE 115 performs ML model monitoring based on the BPM-RS configuration. In some instances, the UE 115 performs the ML model monitoring based on one or more ML monitoring signals transmitted by the BS 105 at action 620. The ML monitoring signals may include one or more reference signals, such as downlink reference signals, CSI-RS, CRS, SSB, etc. In some instances, the BS 105 may periodically transmit the nominal reference signals and/or BPM-RSs as described above with respect to FIGS. 3-5.

In some instances, at action 625, the UE 115 evaluates one or more values associated with a prediction of the ML model to one or more measured values. In some aspects, the UE 115 evaluates the value(s) associated with the prediction of the ML model to the measured value(s) based at least in part on the BPM-RS configuration(s) received at action 610. In this regard, the UE 115 may utilize information from the BPM-RS configuration(s) received at action 610 to evaluate the performance of one or more ML models. In some instances, the UE 115 monitors the performance of the ML model(s) by determining whether a number of errors of the ML model exceeds a BPM threshold prior to an expiration of a BPM timer. The UE 115 may determine, using the ML model and based on the BPM-RS configuration, a predicted measurement for one or more beams associated with the one or more BPM-RS resources. The predicted measurement may be one or more of a level 1 reference signal receive power (L1-RSRP), a level 1 signal to interference noise ratio (L1-SINR), a rank indicator (RI), a precoding matrix indicator (PMI), a channel quality indicator (CQI), layer indicator (LI), and/or other predicted measurement/indicator.

The UE 115 may determine, at action 625, whether an error of the ML model has occurred based on the predicted measurement for the one or more beams. In some aspects, the UE 115 compares one or more values associated with the predicted measurement of the ML model to one or more measured values. For example, in some instances, the UE 115 may compare the predicted measurement to an actual measurement associated with the same beam. In this regard, in some instances the UE 115 may determine the predicted measurement for the one or more beams based on a spatial filter. The spatial filter the UE 115 utilizes to determine the predicted measurement may correspond to a spatial transmit filter associated with the BS 105 transmitting the one or more beams. In some aspects, the UE 115 may compare an actual measurement of a beam corresponding to the predicted measurement to an actual measurement associated with one or more other beams.

In some instances, the UE 115 may determine, at action 625, whether a top-1 predicted beam of the ML model is included in a set of top-K beams of a group of measured beams. For example, referring back to FIG. 3, the UE 115 may determine whether a measurement (e.g., RSRP (e.g., L1-RSRP), RSRQ, RSSI, SINR (e.g., L1-SINR), RI, PMI, CQI, LI, etc.) associated with the top-1 predicted beam of the predicted beam group 315i is within the top-K beams (e.g., top 1, 2, 3, 4, 5, etc. beams) of the group of measured beams of BPM-RS group 320a. In this regard, the predicted measurement associated with the top-1 predicted beam of the predicted beam group 315i may be a measurement of the corresponding beam of the group of measured beams of BPM-RS group 320a. For example, if the ML model predicts that a particular beam (e.g., beam index 2) is the top-1 predicted beam, then the actual measurement of that particular beam (e.g., beam index 2) from the group of measured beams of BPM-RS group 320a may be used as the predicted measurement associated with the top-1 predicted beam of the predicted beam group 315i. In other instances, the predicted measurement as determined by the ML model be used as the predicted measurement. In some aspects, the UE 115 may determine an error of the ML model has occurred if the top-1 predicted beam of the ML model is not included in the set of top-K beams of the group of measured beams.

In some instances, the UE 115 may determine, at action 625, whether a top-1 measured beam of the group of measured beams is included in a set of top-K beams of a group of predicted beams of the ML model. For example, referring back to FIG. 3, the UE 115 may determine whether a top-1 measured beam from the group of measured beams of BPM-RS group 320a is in the top-K beams (e.g., top 1, 2, 3, 4, 5, etc. beams) of the predicted beam group 315i. The determination of the ranking of the beams may be based on RSRP (e.g., L1-RSRP), RSRQ, RSSI, SINR (e.g., L1-SINR), RI, PMI, CQI, LI, etc. In this regard, the measurement of the top-1 measured beam from the group of measured beams of BPM-RS group 320a may be based on the measurements of the beams in the group of measured beams of BPM-RS group 320a. The predicted measurements associated with the top-K predicted beams of the predicted beam group 315i may be measurements of the corresponding beams of the group of measured beams of BPM-RS group 320a. For example, if ML model predicts that particular beams (e.g., beam indexes 2, 3, and 4) are the top-3 predicted beams, then the measurements of those particular beams (e.g., beam indexes 2, 3, and 4) from the group of measured beams of BPM-RS group 320a may be used as the predicted measurements associated with the top-K predicted beams of the predicted beam group 315i. In some instances, the UE 115 may determine an error of the ML model has occurred if the top-1 measured beam of the group of measured beams is not included in the set of top-K beams of the group of predicted beams associated with the prediction of the ML model.

In some instances, the UE 115 may determine, at action 625, whether a L1-RSRP and/or other measurement(s) (e.g., RSRQ, RSSI, SNIR (e.g., L1-SINR), RI, PMI, CQI, LI, etc.) of a top-1 predicted beam of the ML model is within a threshold difference of an L1-RSRP of a top-1 measured beam of the group of measured beams. For example, referring back to FIG. 3, the UE 115 may determine whether the L1-RSRP associated with the top-1 predicted beam of the predicted beam group 315i is within a threshold difference of a measured L1-RSRP of the top-1 beam of the group of measured beams of BPM-RS group 320a. In this regard, the L1-RSRP associated with the top-1 predicted beam of the predicted beam group 315i may be a measurement of the corresponding beam of the group of measured beams of BPM-RS group 320a. For example, if ML model predicts that a particular beam (e.g., beam index 2) is the top-1 predicted beam, then the measurement of that particular beam (e.g., beam index 2) from the group of measured beams of BPM-RS group 320a may be used as the predicted measurement associated with the top-1 predicted beam of the predicted beam group 315i. In some instances, the UE 115 may determine an error of the ML model has occurred if the L1-RSRP and/or other measurement(s) of the top-1 predicted beam of the ML model (e.g., beam index 2) is not within the threshold difference (e.g., 0.5 dB, 1.0 dB, 1.5 dB, or otherwise) of the L1-RSRP of the top-1 measured beam of the group of measured beams.

In some instances, the UE 115 may determine, at action 625, whether an error of the ML model has occurred based on comparing one or more predicted values associated with a prediction of the ML model to one or more measured values associated with a group of measured beams. In some instances, the UE 115 determines whether a predicted L1-RSRP and/or other measurement(s) (e.g., RSRQ, RSSI, SNIR (e.g., L1-SINR), RI, PMI, CQI, LI, etc.) of a top-1 predicted beam of the ML model is within a threshold difference of a measured L1-RSRP of a top-1 measured beam of the group of measured beams. For example, referring back to FIG. 3, the UE 115 may determine whether a predicted L1-RSRP associated with the top-1 predicted beam of the predicted beam group 315i is within a threshold difference of a measured L1-RSRP of the top-1 beam of the group of measured beams of BPM-RS group 320a. In this regard, the measured L1-RSRP associated with the top-1 predicted beam of the predicted beam group 315i may be a measurement of the corresponding beam of the group of measured beams of BPM-RS group 320a. In some aspects, the UE 115 may determine an error of the ML model has occurred if the predicted L1-RSRP or other measurement of the top-1 predicted beam (e.g., beam index 2) of the ML model is not within the threshold difference (e.g., 0.5 dB, 1.0 dB, 1.5 dB, or otherwise) of the measured L1-RSRP of the top-1 measured beam of the group of measured beams.

In some instances, the if the UE 115 determines, at action 625, an error of the ML model has occurred, then the UE 115 may start the BPM timer and determine whether the number of errors of the ML model detected before expiration of the BPM timer satisfies the BPM threshold (e.g., equal to and/or greater than the BPM threshold). In this regard, the UE 115 may increment a BPM counter each time an error is detected and if the BPM counter satisfies the BPM threshold prior to expiration of the BPM timer, then the UE 115 may declare a failure of the ML model.

In some aspects, the UE 115 may detect, based on the monitoring at action 625, one or more ML model failure instance(s) (MFIs) and/or the failure of the ML model. In this manner, the UE 115 may detect the MFIs and/or the failure of the ML model based on the BPM-RS configuration. In some instances, the UE 115 detects an initial MFI based on information from the BPM-RS configuration and/or a ML model monitoring configuration. In this regard, the UE 115 may determine whether an MFI criterion is satisfied for each of a plurality of monitoring occasions. In some aspects, the UE 115 determines whether the MFI criterion is satisfied by evaluating the one or more value(s) associated with the prediction of the ML model relative to the one or more measured value(s).

At action 630, the UE 115 transmits a report. The report may indicate that the ML model is operating properly, has failed, include one or more measurements associated with the BPM-RSs, and/or include one or more operating parameters associated with the ML model (e.g., number of MFIs detected in one or more ML model evaluation periods (e.g., 335, 435, 535)). For example, in response to detecting a failure of the ML model at action 625, the UE may transmit an indication of the failure of the ML model in the report at action 630. The UE may transmit the report to the BS 105 via an RRC message, a PUCCH communication, a PUSCH communication, and/or other suitable communication. In some instances, the UE may determine, based on the ML model monitoring at action 625, that the ML model is operating appropriately. In some aspects, the UE may transmit the report at action 630 with an indication that the ML model is operating properly.

At action 635, the UE may adjust an operation of the ML model. For example, in some instances the UE 115 may receive an instruction to deactivate the ML model, retrain the ML model, and/or adjust one or more operating parameters of the ML model from the BS 105 in response to the UE 115 transmitting the report to the BS 105 at action 630. Upon receiving the instruction to deactivate the ML model, retrain the ML model, and/or adjust one or more operating parameters of the ML model, the UE adjusts an operation of the ML model (e.g., stopping, retraining, and/or adjusting one or more operating parameters) based on the instruction received from the BS 105. In some instances, at action 635 the UE deactivates the ML model, initiates a retraining of the ML model, and/or adjusts one or more operating parameters of the ML model based on detecting a failure of the ML model at action 625. In some instances, at action 635, the UE continues operating the ML model as is. For example, if the ML model is determined to be performing adequately at action 625, then the UE 115 may continue operating the ML model. In some aspects, even if the ML model is determined to be performing adequately at action 625, the UE may adjust one or more operating parameters of the ML model at action 635 in an effort to optimize the accuracy and/or benefits of the ML model.

At action 640, the BS 105 processes the report received at action 630. In some instances, the BS 105 may evaluate performance of one or more ML models of the UE 115 based on information in the report. For example, the BS 105 may utilize the one or more measurements and/or failure indications included in the report to determine an update to one or more parameters of one or more BPM-RS configurations and/or an activate (or deactivate) one or more BPM-RS configurations. In some instances, the BS 105 may determine that the UE 115 should deactivate, retrain, and/or adjust one or more operating parameters of the ML model based on the report received at action 630. In this regard, the BS 105 may transmit an instruction to the UE 115 to deactivate the ML model, retrain the ML model, and/or adjust one or more operating parameters of the ML model from the BS 105 in response to the UE 115 transmitting the report to the BS 105 at action 630.

At action 645, in some aspects the BS 105 may transmit an indication of an update to one or more parameters of one or more BPM-RS configurations and/or an indication to activate (or deactivate) one or more BPM-RS configurations based on processing the report at action 640. In some instances, if the ML model monitoring report notifies the BS 105 of a failure of the ML model, the BS 105 may update the BPM-RS configuration for the UE. For example, if the BS 105 was sending a down-sampled set of reference signals (e.g., less than all reference signal beam directions and/or less than all standard reference signal transmission occasions) and relied on the beam prediction capability of the ML model of the UE 115 at some beam management stages, then the BS 105 may update the BPM-RS configuration for the UE 115 to transmit more reference signals (e.g., more reference signal beam directions and/or more reference signal transmission occasions, up to and including all reference signal beam directions and/or all standard reference signal transmission occasions). At action 645, the BS 105 may transmit the updated BPM-RS configuration(s) to the UE 115. The UE 115 may then utilize the updated BPM-RS configuration(s) to monitor for BPM-RSs from the BS 105 and monitor performance of the ML model(s).

FIG. 7 illustrates a communication and beam prediction monitoring configurations for a ML model monitoring scheme 700 according to one or more aspects of the present disclosure. The ML model monitoring scheme 700 illustrates aspects of a radio resource control (RRC) communication 705 and beam prediction monitoring reference signal (BPM-RS) configurations 710 for monitoring the performance of a ML model in accordance with the present disclosure. In this regard, aspects of the ML model monitoring scheme 700 may be utilized in the context of the wireless communication network 100 as well as with other aspects of the present disclosure, including the time domain beam prediction scheme 300, the spatial domain beam prediction schemes 400 and 500, and the ML model monitoring schemes 600, 800, 810, 820, and 900.

As shown, the RRC communication 705 may include a plurality of BPM-RS configurations 710a, 710b, 710c, . . . , 710n. In some instances, the RRC communication 705 includes a single BPM-RS configuration. In some instances, a network unit transmits the RRC communication 705 to a UE.

Each BPM-RS configuration 710a, 710b, 710c, . . . , 710n may include a BPM-RS configuration identifier field 715a, 715b, 715c, . . . , 715n. The BPM-RS configuration identifier field 715a, 715b, 715c, . . . , 715n may include a BPM-RS configuration identifier (e.g., BPM-RS Config ID_1, BPM-RS Config ID_2, BPM-RS Config ID_n) and/or an indication of the BPM-RS configuration identifier.

Each BPM-RS configuration 710a, 710b, 710c, . . . , 710n may include one or more BPM-RS resource fields 720a, 720b, 720c, . . . , 720n. The BPM-RS resource fields 720a, 720b, 720c, . . . , 720n may indicate one or more BPM-RS resources associated with the corresponding BPM-RS configuration 710a, 710b, 710c, . . . , 710n. Generally, the BPM-RS resource(s) may include time resources, frequency resources, and/or beam directions (e.g., antenna port(s)) associated with one or more BPM-RSs. In this regard, the BPM-RS resources may be associated with periodic BPM-RSs, semi-persistent BPM-RSs, and/or aperiodic BPM-RSs. In some instances, the BPM-RS resources indicated by the BPM-RS resource fields 720a, 720b, 720c, . . . , 720n may be associated with one or more beams (e.g., one or more beams of BPM-RS groups 320a, 320b, 320c, 420a, 420b, 420c, 520a, 520b, 520c) that the UE utilizes to evaluate performance of one or more machine learning (ML) models configured to predict one or more beam parameters. In some instances, the one or more BPM-RS resources may be associated with one or more non-zero power channel state information reference signal (NZP-CSI-RS) resources and/or other reference signal resources. As shown, in some aspects the BPM-RS configurations 710a, 710b, 710c, . . . , 710n may indicate a different number of BPM-RS resources. In some aspects, each BPM-RS configuration 710a, 710b, 710c, . . . , 710n may indicate a same number of BPM-RS resources (e.g., 1, 2, 3, etc.).

Each BPM-RS configuration 710a, 710b, 710c, . . . , 710n may include one or more BPM timer fields 725a, 725b, 725c, . . . , 725n. The BPM timer fields 725a, 725b, 725c, . . . , 720n may indicate one or more BPM timer lengths associated with the corresponding BPM-RS configuration 710a, 710b, 710c, . . . , 710n. In some instances, the BPM timer length(s) indicated by the BPM timer fields 725a, 725b, 725c, . . . , 725n may be utilized by the UE to evaluate performance of one or more ML models configured to predict one or more beam parameters. As shown, in some aspects the BPM-RS configurations 710a, 710b, 710c, . . . , 710n may indicate a different number of BPM timer lengths. In some aspects, each BPM-RS configuration 710a, 710b, 710c, . . . , 710n may indicate a same number of BPM timer lengths (e.g., 1, 2, 3, etc.).

Each BPM-RS configuration 710a, 710b, 710c, . . . , 710n may include one or more BPM-RS counter threshold fields 730a, 730b, 730c, . . . , 730n. The BPM-RS counter threshold fields 730a, 730b, 730c, . . . , 730n may indicate one or more BPM-RS counter thresholds associated with the corresponding BPM-RS configuration 710a, 710b, 710c, . . . , 710n. In some instances, the BPM-RS counter threshold(s) indicated by the BPM-RS counter threshold fields 730a, 730b, 730c, . . . , 730n may be utilized by the UE to evaluate performance of one or more ML models configured to predict one or more beam parameters. As shown, in some aspects the BPM-RS configurations 710a, 710b, 710c, . . . , 710n may indicate a different number of BPM-RS counter thresholds. In some aspects, each BPM-RS configuration 710a, 710b, 710c, . . . , 710n may indicate a same number of BPM-RS counter thresholds (e.g., 1, 2, 3, etc.).

Each BPM-RS configuration 710a, 710b, 710c, . . . , 710n may be associated with a serving cell and/or a bandwidth part. In this regard, each BPM-RS configuration 710a, 710b, 710c, . . . , 710n may include an indication of the serving cell(s) and/or bandwidth part(s) associated with the BPM-RS configuration 710a, 710b, 710c, . . . , 710n.

In some aspects, each BPM-RS configuration 710a, 710b, 710c, . . . , 710n may include one or more additional fields and/or omit one or more of the fields shown in FIG. 7. For example, in some instances each BPM-RS configuration 710a, 710b, 710c, . . . , 710n may include one or more fields for indicating parameters associated with ML model monitoring and/or reporting.

FIG. 8A illustrates communications for a ML model monitoring scheme 800 according to one or more aspects of the present disclosure. The ML model monitoring scheme 800 illustrates aspects of a radio resource control (RRC) communication 705 and a media access control control element (MAC-CE) and/or downlink control information (DCI) communication 805 for monitoring the performance of a ML model in accordance with the present disclosure. In this regard, aspects of the ML model monitoring scheme 800 may be utilized in the context of the wireless communication network 100 as well as with other aspects of the present disclosure, including the time domain beam prediction scheme 300, the spatial domain beam prediction schemes 400 and 500, and the ML model monitoring schemes 600, 700, 810, 820, and 900.

As shown, in some instances the UE receives a plurality of BPM-RS configurations (e.g., BPM-RS configurations 710a, 710b, 710c, . . . , 710n) via the RRC communication 705. The UE may also receive, from the network unit, an indication to use one or more BPM-RS configurations (e.g., BPM-RS configuration 710b) of the plurality of BPM-RS configurations (e.g., BPM-RS configurations 710a, 710b, 710c, . . . , 710n). The UE may receive the indication to use the one or more BPM-RS configurations (e.g., BPM-RS configuration 710b) of the plurality of BPM-RS configurations via the MAC-CE and/or DCI communication 805. In this regard, in some instances the MAC-CE and/or the DCI communication 805 may include an identifier (or an indication of the identifier) associated with each of the BPM-RS configuration(s) the UE is to utilize. For example, as shown in FIG. 8A the MAC-CE and/or the DCI communication 805 includes the identifier, BPM-RS Config ID_2 (or a corresponding indicator), for the BPM-RS configuration 710b. In some instances, a DCI communication may have a particular format and/or use a particular radio network temporary identifier (RNTI) when indicating the CSI report setting (e.g., BPM-RS Config ID_2) to use when multiple CSI report settings are associated with a BPM-RS configuration.

FIG. 8B illustrates communications for a ML model monitoring scheme 810 according to one or more aspects of the present disclosure. The ML model monitoring scheme 810 illustrates aspects of a radio resource control (RRC) communication 705 and a channel state information (CSI) report setting communication 815 for monitoring the performance of a ML model in accordance with the present disclosure. In this regard, aspects of the ML model monitoring scheme 810 may be utilized in the context of the wireless communication network 100 as well as with other aspects of the present disclosure, including the time domain beam prediction scheme 300, the spatial domain beam prediction schemes 400 and 500, and the ML model monitoring schemes 600, 700, 800, 820, and 900. The ML model monitoring scheme 810 is similar in some respects to ML model monitoring scheme 800, but instead of receiving the indication to use one or more BPM-RS configurations of the plurality of BPM-RS configurations via a MAC-CE and/or DCI communication, the UE receives the indication to use the one or more BPM-RS configurations (e.g., BPM-RS configuration 710b) of the plurality of BPM-RS configurations via the CSI report setting communication 815. In this regard, in some instances the CSI report setting communication 815 may include an identifier (or an indication of the identifier) associated with each of the BPM-RS configuration(s) the UE is to utilize. For example, as shown in FIG. 8b the CSI report setting communication 815 includes the identifier, BPM-RS Config ID_2 (or a corresponding indicator), for the BPM-RS configuration 710b.

FIG. 8C illustrates communications for a ML model monitoring scheme 820 according to one or more aspects of the present disclosure. The ML model monitoring scheme 820 illustrates aspects of a radio resource control (RRC) communication 705, a channel state information (CSI) report setting communication 825, and a media access control control element (MAC-CE) and/or downlink control information (DCI) communication 830 for monitoring the performance of a ML model in accordance with the present disclosure. In this regard, aspects of the ML model monitoring scheme 820 may be utilized in the context of the wireless communication network 100 as well as with other aspects of the present disclosure, including the time domain beam prediction scheme 300, the spatial domain beam prediction schemes 400 and 500, and the ML model monitoring schemes 600, 700, 800, 810, and 900.

As shown, in some instances the UE receives a plurality of BPM-RS configurations (e.g., BPM-RS configurations 710a, 710b, 710c, . . . , 710n) via the RRC communication 705. The UE may also receive, from the network unit, an indication to use one or more BPM-RS configurations (e.g., BPM-RS configuration 710b) of the plurality of BPM-RS configurations (e.g., BPM-RS configurations 710a, 710b, 710c, . . . , 710n). In some instances, the UE receives the indication to use one or more BPM-RS configurations of the plurality of BPM-RS configurations by (1) receiving the CSI report setting communication 825 including multiple BPM-RS configuration identifiers (e.g., BPM-RS Config ID_1, BPM-RS Config ID_2, BPM-RS Config ID_3) or corresponding indicators and (2) receiving the MAC-CE and/or DCI communication 830 indicating one or more of the BPM-RS configurations identified in the CSI report setting communication that the UE is to utilize (e.g., BPM-RS configuration 710b). The multiple BPM-RS configurations indicated in the CSI report setting communication 825 may be one or more, including all, of the plurality of BPM-RS configurations (e.g., BPM-RS configurations 710a, 710b, 710c, . . . , 710n). Also, the one or more BPM-RS configurations indicated in the MAC-CE and/or DCI communication 830 may be one or more, including all, of the multiple BPM-RS configurations indicated in the CSI report setting communication 825.

FIG. 9 illustrates communications for a ML model monitoring scheme 900 according to one or more aspects of the present disclosure. The ML model monitoring scheme 900 illustrates aspects of a radio resource control (RRC) communication 705, a beam prediction monitoring reference signal (BPM-RS) configuration 710k, and a media access control control element (MAC-CE) and/or downlink control information (DCI) communication 910 for monitoring the performance of a ML model in accordance with the present disclosure. In this regard, aspects of the ML model monitoring scheme 900 may be utilized in the context of the wireless communication network 100 as well as with other aspects of the present disclosure, including the time domain beam prediction scheme 300, the spatial domain beam prediction schemes 400 and 500, and the ML model monitoring schemes 600, 700, 800, 810, and 820.

In some aspects, the BPM-RS configuration 710k may include a plurality of channel state information (CSI) report setting identifiers 905 (e.g., CSI-Report ID_1, CSI-Report ID_2, CSI-Report ID_3, . . . , CSI-Report ID_n) or indications of the identifiers. When the BPM-RS configuration 710k includes a plurality of CSI report setting identifiers 905 or associated indicators, the UE may receive, from the network unit, an indication to use a CSI report setting of the plurality of CSI report settings. For example, in some instances, the UE may receive the MAC-CE and/or DCI communication 910 including an indication to use a particular CSI report setting (e.g., CSI-Report ID_3). In this regard, the MAC-CE and/or the DCI communication 910 may include the identifier (or an indication of the identifier) for the CSI report setting that the UE is to utilize. The message format, field(s), parameter(s), and/or other aspects of a report transmitted by the UE to the network unit may be based on the CSI report setting indicated in the MAC-CE and/or DCI communication 910. For example, the UE may format and/or populate the report with particular information and/or parameter values based on the CSI report setting indicated in the MAC-CE and/or DCI communication 910.

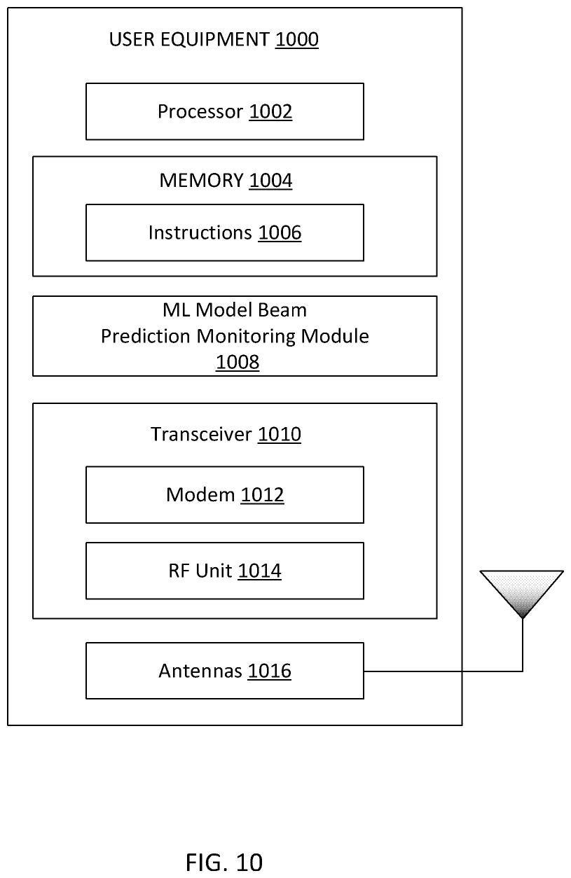

FIG. 10 is a block diagram of a UE 1000 according to one or more aspects of the present disclosure. The UE 1000 may be, for instance, a UE 115 as discussed in FIGS. 1-9. As shown, the UE 1000 may include a processor 1002, a memory 1004, a machine learning (ML) model beam prediction monitoring module 1008, a transceiver 1010 including a modem subsystem 1012 and an RF unit 1014, and one or more antennas 1016. These elements may be coupled with one another. The term “coupled” may refer to directly or indirectly coupled or connected to one or more intervening elements. For instance, these elements may be in direct or indirect communication with each other, for instance via one or more buses.

The processor 1002 may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, solid state memory device, hard disk drives, other forms of volatile and non-volatile memory, or a combination of different types of memory. In an aspect, the memory 1004 includes a non-transitory computer-readable medium. The memory 1004 may store, or have recorded thereon, instructions 1006. The instructions 1006 may include instructions that, when executed by the processor 1002, cause the processor 1002 to perform the operations described herein with reference to a UE 115 in connection with aspects of the present disclosure, for instance, aspects of FIGS. 3-9 and 12. Instructions 1006 may also be referred to as program code. The program code may be for causing a wireless communication device to perform these operations, for instance by causing one or more processors (such as processor 1002) to control or command the UE 1000 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The ML model beam prediction monitoring module 1008 may be implemented via hardware, software, or combinations thereof. For instance, the ML model beam prediction monitoring module 1008 may be implemented as a processor, circuit, and/or instructions 1006 stored in the memory 1004 and executed by the processor 1002. In some aspects, the ML model beam prediction monitoring module 1008 can be integrated within the modem subsystem 1012. For instance, the ML model beam prediction monitoring module 1008 can be implemented by a combination of software components (e.g., executed by a DSP or a general processor) and hardware components (e.g., logic gates and circuitry) within the modem subsystem 1012. The ML model beam prediction monitoring module 1008 may communicate with one or more components of the UE 1000 to implement various aspects of the present disclosure, for instance, aspects of FIGS. 3-9 and 12.

In some aspects, the ML model beam prediction monitoring module 1008 may be configured, along with other components of the UE 1000, to receive one or more beam prediction management reference signal (BPM-RS) configurations. In some aspects, the ML model beam prediction monitoring module 1008 may be configured, along with other components of the UE 1000, to monitor performance of a machine learning (ML) model based at least in part on the BPM-RS configuration. In some aspects, the ML model beam prediction monitoring module 1008 may be configured, along with other components of the UE 1000, to receive, from a network unit, an indication to use one or more BPM-RS configurations of a plurality of BPM-RS configurations. In some aspects, the ML model beam prediction monitoring module 1008 may be configured, along with other components of the UE 1000, to determine whether a number of errors of the ML model exceeds a BPM threshold prior to an expiration of a BPM timer. In some aspects, the ML model beam prediction monitoring module 1008 may be configured, along with other components of the UE 1000, to transmit, to a network unit, a report based on monitoring the performance of the ML model. In some aspects, the ML model beam prediction monitoring module 1008 may be configured, along with other components of the UE 1000, to transmit the report based on a channel state information (CSI) report setting associated with a BPM-RS configuration utilized for monitoring the performance of the ML model.

In some aspects, the ML model beam prediction monitoring module 1008 is further configured to run one or more ML models. In this regard, the ML model beam prediction monitoring module 1008 may be configured, along with other components of the UE 1000, to execute any type of program that relies on machine learning, including without limitation ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

As shown, the transceiver 1010 may include the modem subsystem 1012 and the RF unit 1014. The transceiver 1010 can be configured to communicate bi-directionally with other devices, such as the BSs 105 and/or network units. The modem subsystem 1012 may be configured to modulate and/or encode the data from the memory 1004 and/or the ML model beam prediction monitoring module 1008 according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data (e.g., communication signals, data signals, control signals, capability reports, BPM-RS reports, ML model monitoring reports, ML model failure indications, measurement reports, etc.) from the modem subsystem 1012 (on outbound transmissions). The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the UE 1000 to enable the UE 1000 to communicate with other devices.

The RF unit 1014 may provide the modulated and/or processed data, e.g., data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The transceiver 1010 may provide the demodulated and decoded data (e.g., communication signals, data signals, control signals, BPM-RS configurations, CSI report settings, machine learning (ML) model monitoring configurations, ML model monitoring requests, instructions to deactivate and/or retrain a ML model, etc.) to the ML model beam prediction monitoring module 1008 for processing. The antennas 1016 may include multiple antennas of similar or different designs in order to sustain multiple transmission links.

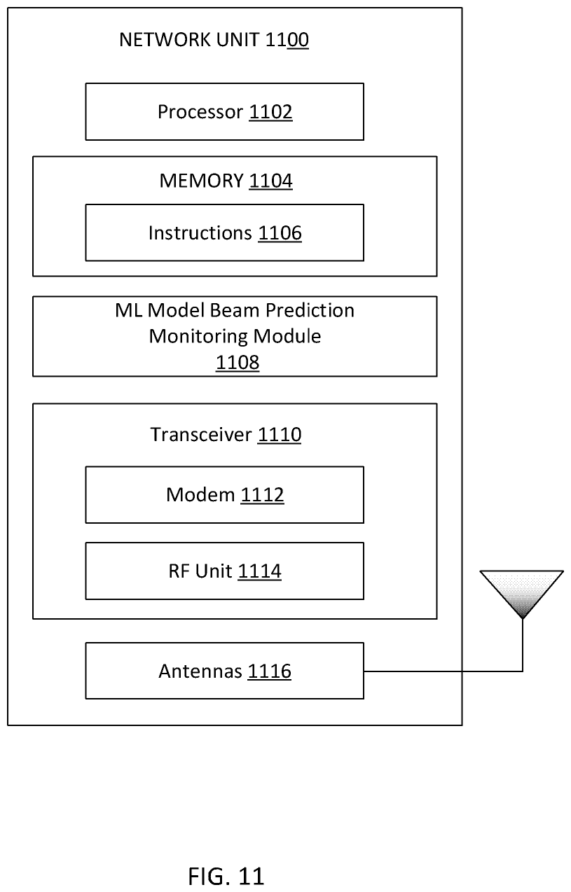

FIG. 11 is a block diagram of a network unit 1100 according to one or more aspects of the present disclosure. The network unit 1100 may be a BS 105, CU 210, DU 230, and/or RU 240 as discussed in FIGS. 1-9. Accordingly, the network unit 1100 may include a BS. The BS may be an aggregated BS or a disaggregated BS, as described above. As shown, the network unit 1100 may include a processor 1102, a memory 1104, a machine learning (ML) monitoring module 1108, a transceiver 1110 including a modem subsystem 1112 and a radio frequency (RF) unit 1114, and one or more antennas 1116. These elements may be coupled with one another. The term “coupled” may refer to directly or indirectly coupled or connected to one or more intervening elements. For instance, these elements may be in direct or indirect communication with each other, for instance via one or more buses.

The processor 1102 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the network unit 1100 to perform operations described herein, for instance, aspects of FIGS. 3-9 and 13. Instructions 1106 may also be referred to as program code. The program code may be for causing a wireless communication device to perform these operations, for instance by causing one or more processors (such as processor 1102) to control or command the network unit 1100 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The ML model beam prediction monitoring module 1108 may be implemented via hardware, software, or combinations thereof. For instance, the ML model beam prediction monitoring module 1108 may be implemented as a processor, circuit, and/or instructions 1106 stored in the memory 1104 and executed by the processor 1102. In some instances, the ML model beam prediction monitoring module 1108 can be integrated within the modem subsystem 1112. For instance, the ML model beam prediction monitoring module 1108 can be implemented by a combination of software components (e.g., executed by a DSP or a general processor) and hardware components (e.g., logic gates and circuitry) within the modem subsystem 1112. The ML model beam prediction monitoring module 1108 may communicate with one or more components of the network unit 1100 to implement various aspects of the present disclosure, for instance, aspects of FIGS. 3-9 and 13.

In some aspects, the ML model beam prediction monitoring module 1108 may be configured, along with other components of the network unit 1100, to transmit, to a user equipment (UE), one or more BPM-RS configurations. In some aspects, the ML model beam prediction monitoring module 1108 may be configured, along with other components of the network unit 1100, to receive, from the UE, a report, wherein the report is associated with the UE monitoring a performance of a machine learning (ML) model based on the first BPM-RS configuration. In some aspects, the ML model beam prediction monitoring module 1108 may be configured, along with other components of the network unit 1100, to set one or more parameters of the BPM-RS configuration. In some aspects, the ML model beam prediction monitoring module 1108 may be configured, along with other components of the network unit 1100, to transmit at least one reference signal for each of a plurality of monitoring occasions associated with the BPM-RS configuration. In some aspects, the ML model beam prediction monitoring module 1108 may be configured, along with other components of the network unit 1100, to transmit, to a UE, an indication to use one or more BPM-RS configurations of a plurality of BPM-RS configurations.

As shown, the transceiver 1110 may include the modem subsystem 1112 and the RF unit 1114. The transceiver 1110 can be configured to communicate bi-directionally with other devices, such as the UE 115, UE 1000, and/or another network unit. The modem subsystem 1112 may be configured to modulate and/or encode data according to a modulation and coding scheme (MCS), e.g., a low-density parity check (LDPC) coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (e.g., communication signals, data signals, control signals, BPM-RS configurations, CSI report settings, machine learning (ML) model monitoring configurations, ML model monitoring requests, instructions to deactivate and/or retrain a ML model, etc.) from the modem subsystem 1112 (on outbound transmissions). The RF unit 1114 may be further configured to perform analog beamforming in conjunction with the digital beamforming. Although shown as integrated together in transceiver 1110, the modem subsystem 1112, and/or the RF unit 1114 may be separate devices that are coupled together at the network unit 1100 to enable the network unit 1100 to communicate with other devices.

The RF unit 1114 may provide the modulated and/or processed data, e.g., data packets (or, more generally, data messages that may contain one or more data packets and other information), to the antennas 1116 for transmission to one or more other devices. The antennas 1116 may further receive data messages transmitted from other devices and provide the received data messages for processing and/or demodulation at the transceiver 1110. The transceiver 1110 may provide the demodulated and decoded data (e.g., communication signals, data signals, control signals, capability reports, BPM-RS reports, ML model monitoring reports, ML model failure indications, measurement reports, etc.) to the ML model beam prediction monitoring module 1108 for processing. The antennas 1116 may include multiple antennas of similar or different designs in order to sustain multiple transmission links.

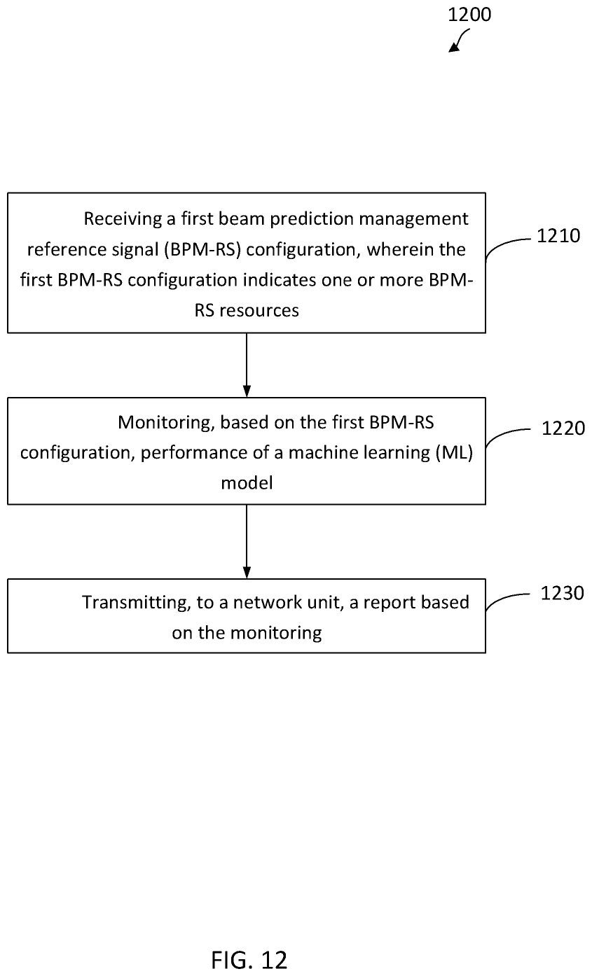

FIG. 12 is a flow diagram illustrating a wireless communication method 1200 according to one or more aspects of the present disclosure. Aspects of the method 1200 can be executed by a computing device (e.g., a processor, processing circuit, and/or other suitable component) of a wireless communication device or other suitable means for performing the blocks. For instance, the wireless communication device may be a UE (e.g., UE 115 or UE 1000). The UE may utilize one or more components, such as the processor 1002, the memory 1004, the ML model beam prediction monitoring module 1008, the transceiver 1010, the modem subsystem 1012, the RF unit 1014, and/or the one or more antennas 1016, to execute the blocks of method 1200. The method 1200 may employ similar mechanisms as described in FIGS. 3-9. As illustrated, the method 1200 includes a number of enumerated blocks, but aspects of the method 1200 may include additional blocks before, after, and in between the enumerated blocks. In some aspects, one or more of the enumerated blocks may be omitted or performed in a different order.

At block 1210, the UE (e.g., UE 115 and/or UE 1000) receives a first beam prediction management reference signal (BPM-RS) configuration. The UE may receive the first BPM-RS configuration from a network unit (e.g., network unit 1100, BS 105, CU 210, DU 230, and/or RU 240). The UE may receive the first BPM-RS configuration from the network unit via a radio resource control (RRC) message or other suitable communication. The first BPM-RS configuration may be included as an information element of the communication.

The first BPM-RS configuration may indicate one or more BPM-RS resources. Generally, the BPM-RS resource(s) may include time resources, frequency resources, and/or beam directions (e.g., antenna port(s)) associated with one or more BPM-RSs. In this regard, the BPM-RS resources may be associated with periodic BPM-RSs, semi-persistent BPM-RSs, and/or aperiodic BPM-RSs. In some instances, the BPM-RS resources may be associated with one or more beams (e.g., one or more beams of BPM-RS groups 320a, 320b, 320c, 420a, 420b, 420c, 520a, 520b, 520c) that the UE utilizes to evaluate performance of one or more machine learning (ML) models configured to predict one or more beam parameters. In some instances, the one or more BPM-RS resources may be associated with one or more non-zero power channel state information reference signal (NZP-CSI-RS) resources and/or other reference signal resources. In some instances, the first BPM-RS configuration may be associated with a serving cell and/or a bandwidth part. In this regard, each serving cell and/or bandwidth part may be associated with one or more BPM-RS configurations.

In some instances, at block 1210, the UE receives a plurality of BPM-RS configurations (e.g., as shown in FIGS. 7-8C). The plurality of BPM-RS configurations may include the first BPM-RS configuration. Each of the plurality of BPM-RS configurations may be associated with at least one of a serving cell or a bandwidth part. In some aspects, the UE receives the plurality of BPM-RS configurations via an RRC communication. In some instances, the UE further receives an indication to use one or more BPM-RS configurations (e.g., the first BPM-RS configuration) of the plurality of BPM-RS configurations (e.g., as shown in FIGS. 8A-8C). The UE may receive the indication to use the one or more BPM-RS configurations (e.g., the first BPM-RS configuration) of the plurality of BPM-RS configurations via a media access control control element (MAC-CE) and/or downlink control information (DCI) (e.g., as shown in FIGS. 8A-8C). In this regard, in some instances the MAC-CE and/or the DCI may include an identifier (or an indication of the identifier) associated with each of the BPM-RS configuration(s) the UE is to utilize.

In some instances, the UE receives the indication to use the one or more BPM-RS configurations of the plurality of BPM-RS configurations by receiving a channel state information (CSI) report setting including multiple BPM-RS configuration identifiers (or indications of the BPM-RS configuration identifiers) associated with one or more of the plurality of BPM-RS configuration(s) (e.g., as shown in FIG. 8C). The multiple BPM-RS configuration indicated in the CSI report setting may be one or more, including all, of the BPM-RS configurations of the plurality of BPM-RS configurations. The UE may then receive an indication indicating one or more BPM-RS configurations of the multiple BPM-RS configurations indicated in the CSI report setting that the UE is to utilize. The UE may receive the indication to use the one or more BPM-RS configurations (e.g., the first BPM-RS configuration) of the multiple of BPM-RS configurations via a MAC-CE and/or DCI (e.g., as shown in FIG. 8C). In this regard, in some instances the MAC-CE and/or the DCI may include an identifier (or an indication of the identifier) associated with each of the BPM-RS configuration(s) the UE is to utilize. In some instances, the DCI may have a particular format and/or use a particular radio network temporary identifier (RNTI) when indicating a CSI report setting to use when multiple CSI report settings are associated with a BPM-RS configuration. In some instances, the UE receives the indication to use the one or more BPM-RS configurations of the plurality of BPM-RS configurations by receiving a CSI report setting including one or more BPM-RS configuration identifiers (or indications of the BPM-RS configuration identifiers) associated with the one or more BPM-RS configurations the UE is to utilize.

In some aspects, the first BPM-RS configuration received at block 1210 includes a plurality of channel state information (CSI) report setting identifiers (or indications of the identifiers) (e.g., as shown in BPM-RS configuration 710k of FIG. 9). When the BPM-RS configuration includes a plurality of CSI report setting identifiers or associated indicators, the UE may receive, from the network unit, an indication to use a particular CSI report setting (e.g., a first CSI report setting) of the plurality of CSI report settings. For example, in some instances, the UE may receive a MAC-CE and/or DCI including an indication to use the particular CSI report setting. In this regard, the MAC-CE and/or the DCI may include the identifier (or an indication of the identifier) for the CSI report setting that the UE is to utilize. As discussed further below, the UE may utilize the associated format and/or parameters for the indicated CSI report setting to send a report to the network unit at block 1230.

In some instances, the first BPM-RS configuration received at block 1210 includes at least one of an indication of a length of a BPM timer (e.g., beamPredictionMonitoringTimer) and/or an indication of a BPM threshold (e.g., beamPredictionErrorCount). In this regard, the UE may utilize the BPM timer and/or the BPM threshold to monitor performance of a ML model as discussed in greater detail below with respect to block 1220. In some instances, a common BPM timer length and/or a common BPM threshold may be utilized for two or more BPM-RS configurations. For example, in some instances the UE may receive, at block 1210, a plurality of BPM-RS configurations (including the first BPM-RS) and also receive an indication of a length of a BPM timer and/or receive an indication of a BPM threshold. The length of the BPM timer received by the UE may be associated with each of the plurality of BPM-RS configurations. Similarly, the BPM threshold received by the UE may be associated with each of the plurality of BPM-RS configurations.

In some aspects, the first BPM-RS configuration includes an indication of a plurality of lengths of the BPM timer (see, e.g., BPM-RS configurations 710a, 710c, 710k of FIGS. 7 and 9). In this regard, the UE may receive from the network unit an indication to use a particular length of the BPM timer (e.g., a first BPM timer length) from among the plurality of lengths. Further, in some instances the UE may receive from the network unit a further indication to use a different length of the BPM timer (e.g., a second BPM timer length). In some aspects, the network unit may determine the length of the BPM timer for the UE to use and communicate an indication of the selected length to the UE. In some instances, the network unit may determine to change the length of the BPM timer based on UE mobility, one or more reports from the UE, network conditions, and/or other factors.

In some aspects, the first BPM-RS configuration includes an indication of a plurality of BPM thresholds (see, e.g., BPM-RS configurations 710a, 710b, 710k of FIGS. 7 and 9). In this regard, the UE may receive from the network unit an indication to use a particular BPM threshold (e.g., a first BPM threshold) from among the plurality of BPM thresholds. Further, in some instances the UE may receive from the network unit a further indication to use a different BPM threshold (e.g., a second BPM threshold). In some aspects, the network unit may determine the BPM threshold for the UE to use and communicate an indication of the selected BPM threshold to the UE. In some instances, the network unit may determine to change the BPM threshold based on UE mobility, one or more reports from the UE, network conditions, and/or other factors.

In some aspects, the BPM-RS configuration may further include one or more other parameters associated with ML model monitoring and/or reporting. For example, the BPM-RS configuration may include one or more values associated with one or more ML model failure criterion (e.g., whether a top-1 predicted beam of the ML model is included in a set of top-K beams of a group of measured beams, whether a top-1 measured beam of a group of measured beams is included in a set of top-K beams of a group of predicted beams of the ML model, whether a layer 1 reference signal receive power (L1-RSRP) or other measurement(s) of a top-1 predicted beam of the ML model is within a threshold difference of an L1-RSRP or other measurement(s) of a top-1 measured beam of a group of measured beams, whether a predicted layer 1 reference signal receive power (L1-RSRP) or other measurement(s) of a top-1 predicted beam of the ML model is within a threshold difference of a measured L1-RSRP or other measurement(s) of a top-1 measured beam of a group of measured beams, etc.) and/or other parameters associated with ML model BPM monitoring and/or reporting. In some instances, the UE may utilize information from the BPM-RS configuration to evaluate the performance of one or more ML models. In some instances, the ML model(s) may include an ML model utilized by the UE for beam prediction. For example, the ML model may be configured to provide a time domain beam prediction (e.g., as discussed with respect to FIG. 3) and/or a spatial domain beam prediction (e.g., as discussed with respect to FIGS. 4 and 5).

At block 1220, the UE monitors, based on the first BPM-RS configuration received at block 1210, performance of a machine learning (ML) model. In some instances, the UE monitors the performance of the ML model by determining whether a number of errors of the ML model exceeds the BPM threshold prior to an expiration of the BPM timer. The UE may determine, using the ML model and based on the BPM-RS configuration, a predicted measurement for one or more beams associated with the one or more BPM-RS resources. The predicted measurement may be one or more of a level 1 reference signal receive power (L1-RSRP), a level 1 signal to interference noise ratio (L1-SINR), a rank indicator (RI), a precoding matrix indicator (PMI), a channel quality indicator (CQI), layer indicator (LI), and/or other predicted measurement/indicator.

The UE may determine whether an error of the ML model has occurred based on the predicted measurement for the one or more beams. In some aspects, the UE compares one or more values associated with the predicted measurement of the ML model to one or more measured values. For example, in some instances, the UE may compare the predicted measurement to an actual measurement associated with the same beam. In this regard, in some instances the UE may determine the predicted measurement for the one or more beams based on a spatial filter. The spatial filter the UE utilizes to determine the predicted measurement may correspond to a spatial transmit filter associated with the network unit transmitting the one or more beams. In some aspects, the UE may compare an actual measurement of a beam corresponding to the predicted measurement to an actual measurement associated with one or more other beams.

In some instances, the UE may determine whether a top-1 predicted beam of the ML model is included in a set of top-K beams of a group of measured beams. For example, referring back to FIG. 3, the UE may determine whether a measurement (e.g., RSRP (e.g., L1-RSRP), RSRQ, RSSI, SINR (e.g., L1-SINR), RI, PMI, CQI, LI, etc.) associated with the top-1 predicted beam of the predicted beam group 315i is within the top-K beams (e.g., top 1, 2, 3, 4, 5, etc. beams) of the group of measured beams of BPM-RS group 320a. In this regard, the predicted measurement associated with the top-1 predicted beam of the predicted beam group 315i may be a measurement of the corresponding beam of the group of measured beams of BPM-RS group 320a. For example, if ML model predicts that a particular beam (e.g., beam index 2) is the top-1 predicted beam, then the actual measurement of that particular beam (e.g., beam index 2) from the group of measured beams of BPM-RS group 320a may be used as the predicted measurement associated with the top-1 predicted beam of the predicted beam group 315i. In other instances, the predicted measurement as determined by the ML model be used as the predicted measurement. In some aspects, the UE may determine an error of the ML model has occurred if the top-1 predicted beam of the ML model is not included in the set of top-K beams of the group of measured beams.

In some instances, the UE may determine whether a top-1 measured beam of the group of measured beams is included in a set of top-K beams of a group of predicted beams of the ML model. For example, referring back to FIG. 3, the UE may determine whether a top-1 measured beam from the group of measured beams of BPM-RS group 320a is in the top-K beams (e.g., top 1, 2, 3, 4, 5, etc. beams) of the predicted beam group 315i. The determination of the ranking of the beams may be based on RSRP (e.g., L1-RSRP), RSRQ, RSSI, SINR (e.g., L1-SINR), RI, PMI, CQI, LI, etc. In this regard, the measurement of the top-1 measured beam from the group of measured beams of BPM-RS group 320a may be based on the measurements of the beams in the group of measured beams of BPM-RS group 320a. The predicted measurements associated with the top-K predicted beams of the predicted beam group 315i may be measurements of the corresponding beams of the group of measured beams of BPM-RS group 320a. For example, if the ML model predicts that particular beams (e.g., beam indexes 2, 3, and 4) are the top-3 predicted beams, then the measurements of those particular beams (e.g., beam indexes 2, 3, and 4) from the group of measured beams of BPM-RS group 320a may be used as the predicted measurements associated with the top-K predicted beams of the predicted beam group 315i. In some instances, the UE may determine an error of the ML model has occurred if the top-1 measured beam of the group of measured beams is not included in the set of top-K beams of the group of predicted beams associated with the prediction of the ML model.

In some instances, the UE may determine whether a L1-RSRP and/or other measurement(s) (e.g., RSRQ, RSSI, SNIR (e.g., L1-SINR), RI, PMI, CQI, LI, etc.) of a top-1 predicted beam of the ML model is within a threshold difference of an L1-RSRP of a top-1 measured beam of the group of measured beams. For example, referring back to FIG. 3, the UE may determine whether the L1-RSRP associated with the top-1 predicted beam of the predicted beam group 315i is within a threshold difference of a measured L1-RSRP of the top-1 beam of the group of measured beams of BPM-RS group 320a. In this regard, the L1-RSRP associated with the top-1 predicted beam of the predicted beam group 315i may be a measurement of the corresponding beam of the group of measured beams of BPM-RS group 320a. For example, if ML model predicts that a particular beam (e.g., beam index 2) is the top-1 predicted beam, then the measurement of that particular beam (e.g., beam index 2) from the group of measured beams of BPM-RS group 320a may be used as the predicted measurement associated with the top-1 predicted beam of the predicted beam group 315i. In some instances, the UE may determine an error of the ML model has occurred if the L1-RSRP and/or other measurement(s) of the top-1 predicted beam of the ML model (e.g., beam index 2) is not within the threshold difference (e.g., 0.5 dB, 1.0 dB, 1.5 dB, or otherwise) of the L1-RSRP of the top-1 measured beam of the group of measured beams.

In some instances, the UE may determine whether an error of the ML model has occurred based on comparing one or more predicted values associated with a prediction of the ML model to one or more measured values associated with a group of measured beams. In some instances, the UE determines whether a predicted L1-RSRP and/or other measurement(s) (e.g., RSRQ, RSSI, SNIR (e.g., L1-SINR), RI, PMI, CQI, LI, etc.) of a top-1 predicted beam of the ML model is within a threshold difference of a measured L1-RSRP of a top-1 measured beam of the group of measured beams. For example, referring back to FIG. 3, the UE may determine whether a predicted L1-RSRP associated with the top-1 predicted beam of the predicted beam group 315i is within a threshold difference of a measured L1-RSRP of the top-1 beam of the group of measured beams of BPM-RS group 320a. In this regard, the measured L1-RSRP associated with the top-1 predicted beam of the predicted beam group 315i may be a measurement of the corresponding beam of the group of measured beams of BPM-RS group 320a. In some aspects, the UE may determine an error of the ML model has occurred if the predicted L1-RSRP or other measurement of the top-1 predicted beam (e.g., beam index 2) of the ML model is not within the threshold difference (e.g., 0.5 dB, 1.0 dB, 1.5 dB, or otherwise) of the measured L1-RSRP of the top-1 measured beam of the group of measured beams.

In some instances, the if the UE determines an error of the ML model has occurred, then the UE may start the BPM timer and determine whether the number of errors of the ML model detected before expiration of the BPM timer satisfies the BPM threshold (e.g., equal to and/or greater than the BPM threshold). In this regard, the UE may increment a BPM counter each time an error is detected and if the BPM counter satisfies the BPM threshold prior to expiration of the BPM timer, then the UE may declare a failure of the ML model.

At block 1230, the UE transmits a report based on the monitoring at block 1220. The UE may transmit the report to the network unit via an RRC message, a PUCCH communication, a PUSCH communication, and/or other suitable communication. In some instances, the report includes an indication of the failure of the ML model. In some instances, the report includes one or more predicted measurements of the ML model. For example, the report may include a predicted measurement of one or more of an L1-RSRP, an L1-SINR, an RI, a PMI, a CQI, an LI, and/or other predicted measurement/indicator. In some aspects, the network unit may utilize predicted measurement(s) associated with ML model to evaluate the performance of the ML model.

In some aspects, the report includes one or more BPM-RS configuration identifiers associated with corresponding BPM-RS configuration(s). In this regard, the predicted measurement and/or the determination of the failure of the ML model by the UE may be based, at least in part, on the BPM-RS configuration indicated in the report. As discussed above, in some instances the UE receives an indication of the BPM-RS configuration(s) to use from the network unit and the UE indicates the corresponding BPM-RS configuration(s) in the report(s). In this regard, in some aspects the UE may transmit a separate report for each BPM-RS configuration. In some aspects, the UE may transmit a single report associated with and/or indicating multiple BPM-RS configurations. In some aspects, the UE transmits the report based on a channel state information (CSI) report setting associated with the one or more BPM-RS configuration(s). In this regard, the message format, field(s), parameter(s), and/or other aspects of the report may be based on the CSI report setting. For example, the UE may format and/or populate the report with particular information and/or parameter values based on the CSI report setting. In some instances, the UE receives an indication of the CSI report setting to use from the network unit.

In some aspects, the UE receives an instruction to deactivate the ML model. For example, the UE may receive from a network unit, in response to UE transmitting the report, the instruction to deactivate the ML model. In some instances, the UE receives an instruction to retrain the ML model. For example, the UE may receive from a network unit, in response to UE transmitting the report, the instruction to retrain the ML model. In some instances, the UE deactivates the ML model based on detecting a failure of the ML model based on the monitoring at block 1220. In some instances, the UE initiates a retraining of the ML model based on detecting a failure of the ML model at block 1220. In some instances, the UE may not detect a failure of the ML model based on the monitoring at block 1220. In some aspects, the UE may include an indication that the ML model is operating properly in the report.

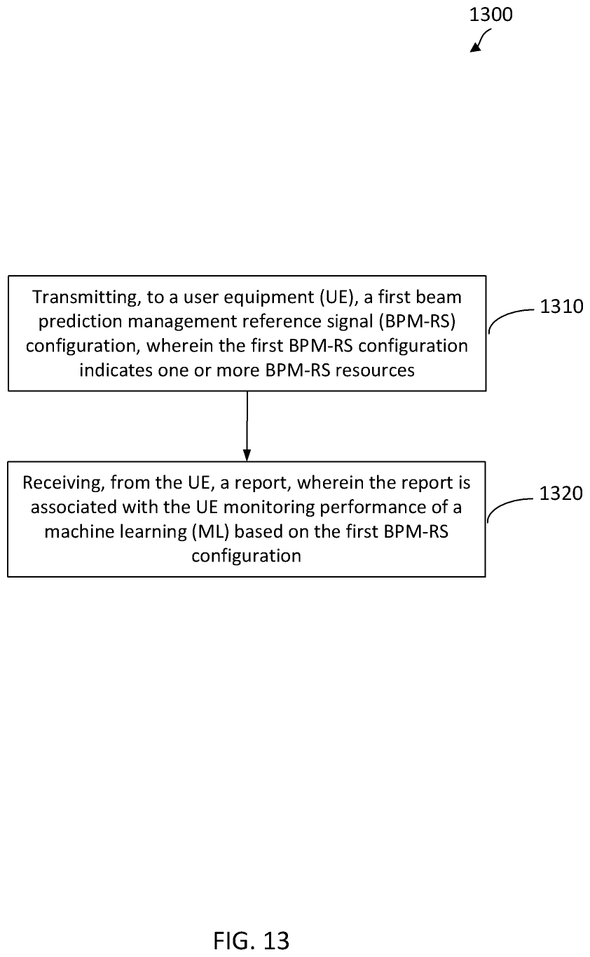

FIG. 13 is a flow diagram illustrating a wireless communication method 1300 according to one or more aspects of the present disclosure. Aspects of the method 1300 can be executed by a computing device (e.g., a processor, processing circuit, and/or other suitable component) of a wireless communication device or other suitable means for performing the blocks. For instance, the wireless communication device may include a network unit (e.g., network unit 1100, BS 105, CU 210, DU 230, and/or RU 240). The network unit 1100 may utilize one or more components, such as the processor 1102, the memory 1104, the ML model beam prediction monitoring module 1108, the transceiver 1110, the modem subsystem 1112, the RF unit 1114, and/or the one or more antennas 1116, to execute the blocks of method 1300. The method 1300 may employ similar mechanisms as described in FIGS. 3-9. As illustrated, the method 1300 includes a number of enumerated blocks, but aspects of the method 1300 may include additional blocks before, after, and in between the enumerated blocks. In some aspects, one or more of the enumerated blocks may be omitted or performed in a different order.

At block 1310, the network unit (network unit 1100, BS 105, CU 210, DU 230, and/or RU 240) transmits a first beam prediction management reference signal (BPM-RS) configuration. The network unit may transmit the BPM-RS configuration to a user equipment (UE) (e.g., UE 115 and/or UE 1000). The network unit may transmit the BPM-RS configuration to the UE via a radio resource control (RRC) message or other suitable communication. The network unit may include the BPM-RS configuration as an information element of the communication. The BPM-RS configuration may enable the UE to monitor performance of a ML model based on one or more BPM-RSs.

The first BPM-RS configuration may indicate one or more BPM-RS resources. Generally, the BPM-RS resource(s) may include time resources, frequency resources, and/or beam directions (e.g., antenna port(s)) associated with one or more BPM-RSs. In this regard, the BPM-RS resources may be associated with periodic BPM-RSs, semi-persistent BPM-RSs, and/or aperiodic BPM-RSs. In some instances, the BPM-RS resources may be associated with one or more beams (e.g., one or more beams of BPM-RS groups 320a, 320b, 320c, 420a, 420b, 420c, 520a, 520b, 520c) that the UE may utilize to evaluate performance of one or more machine learning (ML) models configured to predict one or more beam parameters. In some instances, the one or more BPM-RS resources may be associated with one or more non-zero power channel state information reference signal (NZP-CSI-RS) resources and/or other reference signal resources. In some instances, the first BPM-RS configuration may be associated with a serving cell and/or a bandwidth part. In this regard, each serving cell and/or bandwidth part may be associated with one or more BPM-RS configurations.

In some instances, at block 1310, the network unit transmits a plurality of BPM-RS configurations (e.g., as shown in FIGS. 7-8C). The plurality of BPM-RS configurations may include the first BPM-RS configuration. Each of the plurality of BPM-RS configurations may be associated with at least one of a serving cell or a bandwidth part. In some aspects, the network unit transmits the plurality of BPM-RS configurations via an RRC communication. In some instances, the network unit further transmits to the UE an indication to use one or more BPM-RS configurations (e.g., the first BPM-RS configuration) of the plurality of BPM-RS configurations (e.g., as shown in FIGS. 8A-8C). The network unit may transmit the indication to use the one or more BPM-RS configurations (e.g., the first BPM-RS configuration) of the plurality of BPM-RS configurations via a media access control control element (MAC-CE) and/or downlink control information (DCI) (e.g., as shown in FIGS. 8A-8C). In this regard, in some instances the MAC-CE and/or the DCI may include an identifier (or an indication of the identifier) associated with each of the BPM-RS configuration(s) the UE is to utilize.

In some instances, the network unit transmits the indication to use the one or more BPM-RS configurations of the plurality of BPM-RS configurations by transmitting a channel state information (CSI) report setting including multiple BPM-RS configuration identifiers (or indications of the BPM-RS configuration identifiers) associated with one or more of the plurality of BPM-RS configuration(s) (e.g., as shown in FIG. 8C). The multiple BPM-RS configuration indicated in the CSI report setting may be one or more, including all, of the BPM-RS configurations of the plurality of BPM-RS configurations. The network unit may transmit an indication indicating one or more BPM-RS configurations of the multiple BPM-RS configurations indicated in the CSI report setting that the UE is to utilize. The network unit may transmit the indication to use the one or more BPM-RS configurations (e.g., the first BPM-RS configuration) of the multiple of BPM-RS configurations via a MAC-CE and/or DCI (e.g., as shown in FIG. 8C). In this regard, in some instances the MAC-CE and/or the DCI may include an identifier (or an indication of the identifier) associated with each of the BPM-RS configuration(s) the UE is to utilize. In some instances, the network unit transmits the indication to use the one or more BPM-RS configurations of the plurality of BPM-RS configurations by transmitting a CSI report setting including one or more BPM-RS configuration identifiers (or indications of the BPM-RS configuration identifiers) associated with the one or more BPM-RS configurations the UE is to utilize.

In some aspects, the first BPM-RS configuration transmitted by the network unit at block 1210 includes a plurality of channel state information (CSI) report setting identifiers (or indications of the identifiers) (e.g., as shown in BPM-RS configuration 710k of FIG. 9). When the BPM-RS configuration includes a plurality of CSI report setting identifiers or associated indicators, the network unit may transmit to the UE an indication to use a particular CSI report setting (e.g., a first CSI report setting) of the plurality of CSI report settings. For example, in some instances, the network unit may transmit a MAC-CE and/or DCI including an indication to use the particular CSI report setting. In this regard, the MAC-CE and/or the DCI may include the identifier (or an indication of the identifier) for the CSI report setting that the UE is to utilize. The UE may utilize the associated format and/or parameters for the indicated CSI report setting to send a report to the network unit.

In some instances, the first BPM-RS configuration transmitted at block 1310 includes at least one of an indication of a length of a BPM timer and/or an indication of a BPM threshold. In this regard, the BPM timer and/or the BPM threshold may be utilized by the UE and/or the network unit to monitor performance of a ML model. In some instances, a common BPM timer length and/or a common BPM threshold may be utilized for two or more BPM-RS configurations. For example, in some instances the network unit may transmit, at block 1310, a plurality of BPM-RS configurations (including the first BPM-RS) and also transmit an indication of a length of a BPM timer and/or transmit an indication of a BPM threshold. The length of the BPM timer transmitted by the network unit may be associated with each of the plurality of BPM-RS configurations. Similarly, the BPM threshold transmitted by the network unit may be associated with each of the plurality of BPM-RS configurations.

In some aspects, the first BPM-RS configuration includes an indication of a plurality of lengths of the BPM timer (see, e.g., BPM-RS configurations 710a, 710c, 710k of FIGS. 7 and 9). In this regard, the network unit may transmit to the UE an indication to use a particular length of the BPM timer (e.g., a first BPM timer length) from among the plurality of lengths. Further, in some instances the network unit may transmit to the UE a further indication to use a different length of the BPM timer (e.g., a second BPM timer length). In some aspects, the network unit may determine the length of the BPM timer for the UE to use and communicate an indication of the selected length to the UE. In some instances, the network unit may determine to change the length of the BPM timer based on UE mobility, one or more reports from the UE, network conditions, and/or other factors.

In some aspects, the first BPM-RS configuration includes an indication of a plurality of BPM thresholds (see, e.g., BPM-RS configurations 710a, 710b, 710k of FIGS. 7 and 9). In this regard, the network unit may transmit to the UE an indication to use a particular BPM threshold (e.g., a first BPM threshold) from among the plurality of BPM thresholds. Further, in some instances the network unit may transmit to the UE a further indication to use a different BPM threshold (e.g., a second BPM threshold). In some aspects, the network unit may determine the BPM threshold for the UE to use and communicate an indication of the selected BPM threshold to the UE. In some instances, the network unit may determine to change the BPM threshold based on UE mobility, one or more reports from the UE, network conditions, and/or other factors.

In some aspects, the BPM-RS configuration may further include one or more other parameters associated with ML model monitoring and/or reporting. For example, the BPM-RS configuration may include one or more values associated with one or more ML model failure criterion (e.g., whether a top-1 predicted beam of the ML model is included in a set of top-K beams of a group of measured beams, whether a top-1 measured beam of a group of measured beams is included in a set of top-K beams of a group of predicted beams of the ML model, whether a layer 1 reference signal receive power (L1-RSRP) or other measurement(s) of a top-1 predicted beam of the ML model is within a threshold difference of an L1-RSRP or other measurement(s) of a top-1 measured beam of a group of measured beams, whether a predicted layer 1 reference signal receive power (L1-RSRP) or other measurement(s) of a top-1 predicted beam of the ML model is within a threshold difference of a measured L1-RSRP or other measurement(s) of a top-1 measured beam of a group of measured beams, etc.) and/or other parameters associated with ML model BPM monitoring and/or reporting. In this regard, the network unit may set one or more of the parameters included in the BPM-RS configuration based on network conditions (e.g., traffic patterns, network loads, latency requirements, etc.), network capability, UE capability, and/or other factors. The UE may utilize information from the BPM-RS configuration to evaluate the performance of one or more ML models, including reporting an indication of the performance to the network unit in some instances.

At block 1320, the network unit receives a report. The network unit may receive the report from a UE. The report may be associated with the UE monitoring a performance of a machine learning (ML) model. In this regard, the UE may monitor the performance of the ML model based on the BPM-RS configuration(s) transmitted by the network unit at block 1310. The network unit may receive the report to the network unit via an RRC message, a PUCCH communication, a PUSCH communication, and/or other suitable communication. In some instances, the report includes an indication of the failure of the ML model. In some instances, the report includes one or more predicted measurements of the ML model. For example, the report may include a predicted measurement of one or more of an L1-RSRP, an L1-SINR, an RI, a PMI, a CQI, an LI, and/or other predicted measurement/indicator. In some aspects, the network unit may utilize predicted measurement(s) associated with ML model to evaluate the performance of the ML model.

In some aspects, the report includes one or more BPM-RS configuration identifiers associated with corresponding BPM-RS configuration(s). In this regard, the predicted measurement and/or the determination of the failure of the ML model by the UE may be based, at least in part, on the BPM-RS configuration indicated in the report. As discussed above, in some instances the network unit transmits an indication of the BPM-RS configuration(s) for the UE to use and the UE indicates the corresponding BPM-RS configuration(s) in the report(s). In this regard, in some aspects the network unit may receive a separate report for each BPM-RS configuration. In some aspects, the network unit may receive a single report associated with and/or indicating multiple BPM-RS configurations. In some aspects, the network unit receives the report based on a channel state information (CSI) report setting associated with the one or more BPM-RS configuration(s). In this regard, the message format, field(s), parameter(s), and/or other aspects of the report may be based on the CSI report setting. For example, the UE may format and/or populate the report with particular information and/or parameter values based on the CSI report setting. In some instances, the network unit transmits to the UE an indication of the CSI report setting for the UE to use.

In some aspects, the network unit transmits an instruction to the UE to deactivate the ML model. For example, the network unit may transmit to the UE the instruction to deactivate the ML model in response to receiving the report from the UE. In some instances, the network unit transmits an instruction to the UE to retrain the ML model. For example, the network unit may transmit to the UE the instruction to retrain the ML model in response to receiving the report from the UE. In some instances, the report received from the UE includes an indication that the ML model is operating properly.

In some aspects, the network unit transmits at least one BPM-RS for one or more monitoring occasions associated with the BPM-RS configuration. For example, the network unit may transmit BPM-RSs (e.g., downlink reference signals, CSI-RS, CRS, SSB, etc.) associated with the one or more monitoring occasions as described above with respect to FIGS. 3-5. In this regard, the network unit may transmit nominal reference signals (e.g., 305, 405, 505) and/or BPM-RSs (e.g., 320, 420, 520) during normal operation and/or during a ML model evaluation period (e.g., 335, 435, 535).

Other aspects of the present disclosure include:

Clause 1. A method of wireless communication performed by a user equipment (UE), the method comprising:
receiving a first beam prediction management reference signal (BPM-RS) configuration, wherein the first BPM-RS configuration indicates one or more BPM-RS resources;
monitoring, based on the first BPM-RS configuration, performance of a machine learning (ML) model; and
transmitting, to a network unit, a report based on the monitoring.
   Clause 2. The method of clause 1, wherein the receiving the first BPM-RS configuration comprises:
receiving a plurality of BPM-RS configurations, the plurality of BPM-RS configurations including the first BPM-RS configuration.
   Clause 3. The method of clause 2, wherein each of the plurality of BPM-RS configurations is associated with at least one of a serving cell or a bandwidth part.
   Clause 4. The method of clause 2, wherein the receiving the plurality of BPM-RS configurations comprises:
receiving the plurality of BPM-RS configurations via a radio resource control (RRC) communication.
   Clause 5. The method of clause 2, further comprising:
receiving, from the network unit, an indication to use the first BPM-RS configuration of the plurality of BPM-RS configurations.
   Clause 6. The method of clause 5, wherein the receiving the indication to use the first BPM-RS configuration comprises:
receiving at least one of:
   a media access control control element (MAC-CE) including the indication to use the first BPM-RS configuration; or
   downlink control information (DCI) including the indication to use the first BPM-RS configuration.
      Clause 7. The method of clause 6, wherein the receiving the indication to use the first BPM-RS configuration comprises:
receiving a channel state information (CSI) report setting including multiple BPM-RS configuration identifiers, the multiple BPM-RS configuration identifiers including a BPM-RS configuration identifier associated with the first BPM-RS configuration; and receiving at least one of:
   the MAC-CE including the indication to use the first BPM-RS configuration, the MAC-CE including the BPM-RS configuration identifier associated with the first BPM-RS configuration; or
   the DCI including the indication to use the first BPM-RS configuration, the DCI including the BPM-RS configuration identifier associated with the first BPM-RS configuration.
      Clause 8. The method of clause 5, wherein the receiving the indication to use the first BPM-RS configuration comprises:
receiving a channel state information (CSI) report setting including a BPM-RS configuration identifier associated with the first BPM-RS configuration.
   Clause 9. The method of any of clauses 1-8, wherein the first BPM-RS configuration further comprises a plurality of channel state information (CSI) report setting identifiers; and
further comprising:
   receiving, from the network unit, an indication to use a first CSI report setting identifier of the plurality of CSI report setting identifiers.
      Clause 10. The method of clause 9, wherein the receiving the indication to use the first CSI report setting identifier comprises:
receiving at least one of:
   a media access control control element (MAC-CE) including the indication to use the first CSI report setting identifier; or
   downlink control information (DCI) including the indication to use the first CSI report setting identifier.
      Clause 11. The method of any of clauses 1-10, wherein the first BPM-RS configuration further comprises:
an indication of a length of a BPM timer; and
an indication of a BPM threshold.
   Clause 12. The method of clause 11, wherein the monitoring the performance of the ML model comprises:
determining whether a number of errors of the ML model exceeds the BPM threshold prior to an expiration of the BPM timer.
   Clause 13. The method of clause 12, wherein the determining whether the number of errors of the ML model exceeds the BPM threshold prior to the expiration of the BPM timer comprises:
determining, using the ML model and based on the BPM-RS configuration, a predicted measurement for one or more beams associated with the one or more BPM-RS resources; and
determining whether an error of the ML model has occurred based on the predicted measurement for the one or more beams.
   Clause 14. The method of clause 13, wherein the determining the predicted measurement for the one or more beams associated with the one or more BPM-RS resources comprises:
determining the predicted measurement for the one or more beams based on a spatial filter, wherein the spatial filter corresponds to a spatial transmit filter associated with the network unit transmitting the one or more beams.
   Clause 15. The method of clause 14, wherein the predicted measurement comprises at least one of:
a level 1 reference signal receive power (L1-RSRP);
a level 1 signal to interference noise ratio (L1-SINR);
a rank indicator (RI);
a precoding matrix indicator (PMI);
a channel quality indicator (CQI); or
layer indicator (LI).
   Clause 16. The method of any of clauses 1-15, wherein the receiving the first BPM-RS configuration comprises:
receiving a plurality of BPM-RS configurations, the plurality of BPM-RS configurations including the first BPM-RS configuration; and
further comprising:
   receiving an indication of a length of a BPM timer, wherein the length of the BPM timer is associated with each of the plurality of BPM-RS configurations; and
   receiving an indication of a BPM threshold, wherein the BPM threshold is associated with each of the plurality of BPM-RS configurations.
      Clause 17. The method of any of clauses 1-16, wherein the first BPM-RS configuration further comprises an indication of a plurality of lengths of a BPM timer; and
further comprising:
   receiving an indication to use a first length of the BPM timer, wherein the plurality of lengths of the BPM timer includes the first length of the BPM timer.
      Clause 18. The method of clause 17, further comprising:
receiving an indication to use a second length of the BPM timer, wherein the plurality of lengths of the BPM timer includes the second length of the BPM timer and the second length of the BPM timer is different than the first length of the BPM timer.
   Clause 19. The method of any of clauses 1-18, wherein the first BPM-RS configuration further comprises an indication of a plurality of BPM thresholds; and
further comprising:
   receiving an indication to use a first BPM threshold, wherein the plurality of BPM thresholds includes the first BPM threshold.
      Clause 20. The method of clause 19, further comprising:
receiving an indication to use a second BPM threshold, wherein the plurality of BPM thresholds includes the second BPM threshold and the second BPM threshold is different than the first BPM threshold.
   Clause 21. The method of any of clauses 1-20, wherein the report includes a BPM-RS configuration identifier associated with the first BPM-RS configuration.
   Clause 22. The method of any of clauses 1-21, wherein the transmitting the report comprises:
transmitting the report based on a channel state information (CSI) report setting associated with the first BPM-RS configuration.
   Clause 23. The method of any of clauses 1-22, wherein the one or more BPM-RS resources are associated with one or more non-zero power channel state information reference signal (NZP-CSI-RS) resources.
   Clause 24. A method of wireless communication performed by a network unit, the method comprising:
transmitting, to a user equipment (UE), a first beam prediction management reference signal (BPM-RS) configuration, wherein the first BPM-RS configuration indicates one or more BPM-RS resources; and
receiving, from the UE, a report, wherein the report is associated with the UE monitoring a performance of a machine learning (ML) model based on the first BPM-RS configuration.
   Clause 25. The method of clause 24, wherein the transmitting the first BPM-RS configuration comprises:
transmitting a plurality of BPM-RS configurations, the plurality of BPM-RS configurations including the first BPM-RS configuration.
   Clause 26. The method of clause 25, wherein each of the plurality of BPM-RS configurations is associated with at least one of a serving cell or a bandwidth part.
   Clause 27. The method of clause 26, wherein the transmitting the plurality of BPM-RS configurations comprises:
transmitting the plurality of BPM-RS configurations via a radio resource control (RRC) communication.
   Clause 28. The method of clause 26, further comprising:
transmitting, to the UE, an indication to use the first BPM-RS configuration of the plurality of BPM-RS configurations.
   Clause 29. The method of clause 28, wherein the transmitting the indication to use the first BPM-RS configuration comprises:
transmitting at least one of:
   a media access control control element (MAC-CE) including the indication to use the first BPM-RS configuration; or
   downlink control information (DCI) including the indication to use the first BPM-RS configuration.
      Clause 30. The method of clause 29, wherein the transmitting the indication to use the first BPM-RS configuration comprises:
transmitting a channel state information (CSI) report setting including multiple BPM-RS configuration identifiers, the multiple BPM-RS configuration identifiers including a BPM-RS configuration identifier associated with the first BPM-RS configuration; and
transmitting at least one of:
   the MAC-CE including the indication to use the first BPM-RS configuration, the MAC-CE including the BPM-RS configuration identifier associated with the first BPM-RS configuration; or
   the DCI including the indication to use the first BPM-RS configuration, the DCI including the BPM-RS configuration identifier associated with the first BPM-RS configuration.
      Clause 31. The method of clause 28, wherein the transmitting the indication to use the first BPM-RS configuration comprises:
transmitting a channel state information (CSI) report setting including a BPM-RS configuration identifier associated with the first BPM-RS configuration.
   Clause 32. The method of any of clauses 24-31, wherein the first BPM-RS configuration further comprises a plurality of channel state information (CSI) report setting identifiers; and
further comprising:
   transmitting, to the UE, an indication to use a first CSI report setting identifier of the plurality of CSI report setting identifiers.
      Clause 33. The method of clause 32, wherein the transmitting the indication to use the first CSI report setting identifier comprises:
transmitting at least one of:
   a media access control control element (MAC-CE) including the indication to use the first CSI report setting identifier; or
   downlink control information (DCI) including the indication to use the first CSI report setting identifier.
      Clause 34. The method of any of clauses 24-33, wherein the first BPM-RS configuration further comprises:
an indication of a length of a BPM timer; and
an indication of a BPM threshold.
   Clause 35. The method of clause 34, wherein the report comprises an indication of a failure of the ML model.
   Clause 36. The method of any of clauses 24-35, wherein the report comprises an indication of a predicted measurement of the ML model for one or more beams associated with the one or more BPM-RS resources.
   Clause 37. The method of clause 36, wherein the predicted measurement comprises at least one of:
a level 1 reference signal receive power (L1-RSRP);
a level 1 signal to interference noise ratio (L1-SINR);
a rank indicator (RI);
a precoding matrix indicator (PMI);
a channel quality indicator (CQI); or
layer indicator (LI).
   Clause 38. The method of any of clauses 24-37, wherein the transmitting the first BPM-RS configuration comprises:
transmitting a plurality of BPM-RS configurations, the plurality of BPM-RS configurations including the first BPM-RS configuration; and
further comprising:
   transmitting an indication of a length of a BPM timer, wherein the length of the BPM timer is associated with each of the plurality of BPM-RS configurations; and
   transmitting an indication of a BPM threshold, wherein the BPM threshold is associated with each of the plurality of BPM-RS configurations.
      Clause 39. The method of any of clauses 24-38, wherein the first BPM-RS configuration further comprises an indication of a plurality of lengths of a BPM timer; and
further comprising:
   transmitting an indication to use a first length of the BPM timer, wherein the plurality of lengths of the BPM timer includes the first length of the BPM timer.
      Clause 40. The method of clause 39, further comprising:
transmitting an indication to use a second length of the BPM timer, wherein the plurality of lengths of the BPM timer includes the second length of the BPM timer and the second length of the BPM timer is different than the first length of the BPM timer.
   Clause 41. The method of any of clauses 24-40, wherein the first BPM-RS configuration further comprises an indication of a plurality of BPM thresholds; and
further comprising:
   transmitting an indication to use a first BPM threshold, wherein the plurality of BPM thresholds includes the first BPM threshold.
      Clause 42. The method of clause 41, further comprising:
transmitting an indication to use a second BPM threshold, wherein the plurality of BPM thresholds includes the second BPM threshold and the second BPM threshold is different than the first BPM threshold.
   Clause 43. The method of any of clauses 24-42, wherein the report includes a BPM-RS configuration identifier associated with the first BPM-RS configuration.
   Clause 44. The method of any of clauses 24-43, wherein the receiving the report comprises: receiving the report based on a channel state information (CSI) report setting associated with the first BPM-RS configuration.
   Clause 45. The method of any of clauses 24-44, wherein the one or more BPM-RS resources are associated with one or more non-zero power channel state information reference signal (NZP-CSI-RS) resources.
   Clause 46. A non-transitory computer-readable medium storing one or more instructions for wireless communication, the one or more instructions comprising one or more instructions that, when executed by one or more processors of a UE, cause the UE to perform any one of clauses 1-23.
   Clause 47. A non-transitory computer-readable medium storing one or more instructions for wireless communication, the one or more instructions comprising one or more instructions that, when executed by one or more processors of a network unit, cause the network unit to perform any one of aspects of aspects of clauses 24-45.
   Clause 48. A user equipment (UE) comprising one or more means to perform any one or more aspects of clauses 1-23.
   Clause 49. A network unit comprising one or more means to perform any one or more aspects of clauses 24-45.
   Clause 50. A user equipment (UE) comprising: a memory; a transceiver; and at least one processor coupled to the memory and the transceiver, wherein the UE is configured to perform any one or more aspects of clauses 1-23.
   Clause 51. A network unit comprising: a memory; a transceiver; and at least one processor coupled to the memory and the transceiver, wherein the network unit is configured to perform any one or more aspects of clauses 24-45.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

1. A method of wireless communication performed by a user equipment (UE), the method comprising:
receiving a first beam prediction management reference signal (BPM-RS) configuration, wherein the first BPM-RS configuration indicates one or more BPM-RS resources;
monitoring, based on the first BPM-RS configuration, performance of a machine learning (ML) model; and
transmitting, to a network unit, a report based on the monitoring.

2. The method of claim 1, wherein the receiving the first BPM-RS configuration comprises:
receiving a plurality of BPM-RS configurations, the plurality of BPM-RS configurations including the first BPM-RS configuration, wherein each of the plurality of BPM-RS configurations is associated with at least one of a serving cell or a bandwidth part.

3. The method of claim 2, wherein the receiving the plurality of BPM-RS configurations comprises:
receiving the plurality of BPM-RS configurations via a radio resource control (RRC) communication.

4. The method of claim 2, further comprising:
receiving, from the network unit, an indication to use the first BPM-RS configuration of the plurality of BPM-RS configurations.

5. The method of claim 4, wherein the receiving the indication to use the first BPM-RS configuration comprises:
receiving at least one of:
a media access control control element (MAC-CE) including the indication to use the first BPM-RS configuration; or
downlink control information (DCI) including the indication to use the first BPM-RS configuration.

6. The method of claim 5, wherein the receiving the indication to use the first BPM-RS configuration comprises:
receiving a channel state information (CSI) report setting including multiple BPM-RS configuration identifiers, the multiple BPM-RS configuration identifiers including a BPM-RS configuration identifier associated with the first BPM-RS configuration; and
receiving at least one of:
the MAC-CE including the indication to use the first BPM-RS configuration, the MAC-CE including the BPM-RS configuration identifier associated with the first BPM-RS configuration; or
the DCI including the indication to use the first BPM-RS configuration, the DCI including the BPM-RS configuration identifier associated with the first BPM-RS configuration.

7. The method of claim 4, wherein the receiving the indication to use the first BPM-RS configuration comprises:
receiving a channel state information (CSI) report setting including a BPM-RS configuration identifier associated with the first BPM-RS configuration.

8. The method of claim 1, wherein the first BPM-RS configuration further comprises a plurality of channel state information (CSI) report setting identifiers; and
further comprising:
receiving, from the network unit, an indication to use a first CSI report setting identifier of the plurality of CSI report setting identifiers.

9. The method of claim 1, wherein:
the first BPM-RS configuration further comprises:
an indication of a length of a BPM timer; and
an indication of a BPM threshold; and
the monitoring the performance of the ML model comprises:
determining whether a number of errors of the ML model exceeds the BPM threshold prior to an expiration of the BPM timer.

10. The method of claim 9, wherein the determining whether the number of errors of the ML model exceeds the BPM threshold prior to the expiration of the BPM timer comprises:
determining, using the ML model and based on the BPM-RS configuration and based on a spatial filter, a predicted measurement for one or more beams associated with the one or more BPM-RS resources, wherein the spatial filter corresponds to a spatial transmit filter associated with the network unit transmitting the one or more beams; and
determining whether an error of the ML model has occurred based on the predicted measurement for the one or more beams.

11. The method of claim 10, wherein the predicted measurement comprises at least one of:
a level 1 reference signal receive power (L1-RSRP);
a level 1 signal to interference noise ratio (L1-SINR);
a rank indicator (RI);
a precoding matrix indicator (PMI);
a channel quality indicator (CQI); or
layer indicator (LI).

12. The method of claim 1, wherein the first BPM-RS configuration further comprises an indication of a plurality of lengths of a BPM timer; and
further comprising:
receiving an indication to use a first length of the BPM timer, wherein the plurality of lengths of the BPM timer includes the first length of the BPM timer.

13. The method of claim 1, wherein the first BPM-RS configuration further comprises an indication of a plurality of BPM thresholds; and
further comprising:
receiving an indication to use a first BPM threshold, wherein the plurality of BPM thresholds includes the first BPM threshold.

14. The method of claim 1, wherein the report includes a BPM-RS configuration identifier associated with the first BPM-RS configuration.

15. The method of claim 1, wherein the transmitting the report comprises:
transmitting the report based on a channel state information (CSI) report setting associated with the first BPM-RS configuration.

16. A method of wireless communication performed by a network unit, the method comprising:
transmitting, to a user equipment (UE), a first beam prediction management reference signal (BPM-RS) configuration, wherein the first BPM-RS configuration indicates one or more BPM-RS resources; and
receiving, from the UE, a report, wherein the report is associated with the UE monitoring a performance of a machine learning (ML) model based on the first BPM-RS configuration.

17. The method of claim 16, wherein the transmitting the first BPM-RS configuration comprises:
transmitting a plurality of BPM-RS configurations, the plurality of BPM-RS configurations including the first BPM-RS configuration, wherein each of the plurality of BPM-RS configurations is associated with at least one of a serving cell or a bandwidth part.

18. The method of claim 17, further comprising:
transmitting, to the UE, an indication to use the first BPM-RS configuration of the plurality of BPM-RS configurations.

19. The method of claim 16, wherein the first BPM-RS configuration further comprises a plurality of channel state information (CSI) report setting identifiers; and
further comprising:
transmitting, to the UE, an indication to use a first CSI report setting identifier of the plurality of CSI report setting identifiers.

20. The method of claim 16, wherein the first BPM-RS configuration further comprises:
an indication of a length of a BPM timer; and
an indication of a BPM threshold.

21. The method of claim 16, wherein the transmitting the first BPM-RS configuration comprises:
transmitting a plurality of BPM-RS configurations, the plurality of BPM-RS configurations including the first BPM-RS configuration; and
further comprising:
transmitting an indication of a length of a BPM timer, wherein the length of the BPM timer is associated with each of the plurality of BPM-RS configurations; and
transmitting an indication of a BPM threshold, wherein the BPM threshold is associated with each of the plurality of BPM-RS configurations.

22. The method of claim 16, wherein the first BPM-RS configuration further comprises an indication of a plurality of lengths of a BPM timer; and
further comprising:
transmitting an indication to use a first length of the BPM timer, wherein the plurality of lengths of the BPM timer includes the first length of the BPM timer.

23. The method of claim 16, wherein the first BPM-RS configuration further comprises an indication of a plurality of BPM thresholds; and
further comprising:
transmitting an indication to use a first BPM threshold, wherein the plurality of BPM thresholds includes the first BPM threshold.

24. The method of claim 16, wherein the receiving the report comprises:
receiving the report based on a channel state information (CSI) report setting associated with the first BPM-RS configuration.

25. A user equipment (UE), comprising:
a memory;
a transceiver; and
a processor in communication with the memory and the transceiver, wherein the UE is configured to:
receive a first beam prediction management reference signal (BPM-RS) configuration, wherein the first BPM-RS configuration indicates one or more BPM-RS resources;
monitor, based on the first BPM-RS configuration, performance of a machine learning (ML) model; and
transmit, to a network unit, a report based on the monitoring.

26. The UE of claim 25, wherein the UE is further configured to:
receive a plurality of BPM-RS configurations, the plurality of BPM-RS configurations including the first BPM-RS configuration, wherein each of the plurality of BPM-RS configurations is associated with at least one of a serving cell or a bandwidth part; and
receiving, from the network unit, an indication to use the first BPM-RS configuration of the plurality of BPM-RS configurations.

27. The UE of claim 25, wherein the UE is further configured to:
transmit the report based on a channel state information (CSI) report setting associated with the first BPM-RS configuration.

28. A network unit, comprising:
a memory;
a transceiver; and
a processor in communication with the processor and the transceiver, wherein the network unit is configured to:
transmit, to a user equipment (UE), a first beam prediction management reference signal (BPM-RS) configuration, wherein the first BPM-RS configuration indicates one or more BPM-RS resources; and
receive, from the UE, a report, wherein the report is associated with the UE monitoring a performance of a machine learning (ML) model based on the first BPM-RS configuration.

29. The network unit of claim 28, wherein the network unit is further configured to:
transmit, to the UE, a plurality of BPM-RS configurations, the plurality of BPM-RS configurations including the first BPM-RS configuration, wherein each of the plurality of BPM-RS configurations is associated with at least one of a serving cell or a bandwidth part; and
transmit, to the UE, an indication to use the first BPM-RS configuration of the plurality of BPM-RS configurations.

30. The network unit of claim 28, wherein the receiving the report comprises:
receiving the report based on a channel state information (CSI) report setting associated with the first BPM-RS configuration.
